(19) United States
(12) Patent Application Publication
(10) Pub. No.: US 2023/0334559 A1
(43) Pub. Date: Oct. 19, 2023

(54) METHOD AND APPARATUS FOR DECORATING VIRTUAL ROOM, DEVICE, MEDIUM, AND PROGRAM PRODUCT

(71) Applicant: TENCENT TECHNOLOGY (SHENZHEN) COMPANY LIMITED, Shenzhen (CN)

(72) Inventor: Xiang LI, Shenzhen (CN)

(21) Appl. No.: 18/340,974

(22) Filed: Jun. 26, 2023

Related U.S. Application Data
(63) Continuation of application No. PCT/CN2022/131800, filed on Nov. 15, 2022.

(30) Foreign Application Priority Data
Jan. 28, 2022 (CN) 202210108624.X

(51) Int. Cl. G06Q 30/0601; G06T 19/20; G06T 13/40; G06Q 20/12; H04L 51/046

(52) U.S. Cl. CPC G06Q 30/0643; G06T 19/20; G06T 13/40; G06Q 30/0621; G06Q 30/0625; G06Q 20/1235; H04L 51/046; G06T 2219/2004

(57) ABSTRACT

This application discloses a method for decorating a virtual room, relating to the field of virtual worlds. The method includes displaying a first virtual room and a first virtual character in the first virtual room, the first virtual room and the first virtual character being associated with a first account; displaying a second virtual room, and controlling the first virtual character to enter the second virtual room, and at least one virtual item being placed in the second virtual room; displaying a purchase interface for a target item in response to a selection operation on the target item; purchasing the target item by the first account; controlling the first virtual character to return to the first virtual room; and placing the target item in the first virtual room in response to a placement operation.

### RELATED APPLICATIONS

This application is a continuation of PCT Application No. PCT/CN2022/131800, filed on Nov. 15, 2022, which claims priority to Chinese Patent Application No. 202210108624.X, entitled “METHOD AND APPARATUS FOR DECORATING VIRTUAL ROOM, DEVICE, AND MEDIUM” filed with the China National Intellectual Property Administration on Jan. 28, 2022. The two applications are both incorporated by reference in their entirety.

### FIELD OF THE TECHNOLOGY

This application relates to the field of virtual worlds, and in particular, to decoration of a virtual room.

### BACKGROUND OF THE DISCLOSURE

In a virtual world, in order to enhance players' experience, target items are usually sold to players.

Often, a player may select item designs displayed in a target item list after entering a virtual mall, and perform a purchase operation after determining a selected target item to obtain the corresponding target item.

The target item list usually exhibits item designs of many target items. As a result, the player spends a long time determining a desired target item, whereby human-machine interaction efficiency is low.

### SUMMARY

Embodiments of this application provide a method and apparatus for decorating a virtual room, a device, a medium, and a program product. By displaying at least one placed target item in a second virtual room, a first account can intuitively obtain usage of the target item in the second virtual room, and place the target item in a first virtual room belonging to the first account to improve human-machine interaction efficiency. The technical solutions are as follows:

One aspect of this application provides a method for decorating a virtual room. The method includes displaying a first virtual room and a first virtual character in the first virtual room, the first virtual room and the first virtual character being associated with a first account; displaying a second virtual room, and controlling the first virtual character to enter the second virtual room, at least one virtual item being placed in the second virtual room; displaying a purchase interface for a target item in the second virtual room in response to a selection operation on the target item; purchasing the target item by the first account in response to a purchase operation on the purchase interface; controlling the first virtual character to return to the first virtual room; and placing the target item in the first virtual room in response to a placement operation.

Another aspect of this application provides a method for decorating a virtual room. The method includes receiving an identifier, transmitted by a client, of a first virtual room, the client being logged into a first account; transmitting first room data of the first virtual room to the client, the first room data being used for the client to display the first virtual room and a first virtual character in the first virtual room, and the first virtual room and the first virtual character being associated with the first account; receiving a first room switching request transmitted by the client, and transmitting second room data of a second virtual room to the client, the second room data being used for the client to display the second virtual room, at least one virtual item being placed in the second virtual room; receiving a purchase request for a target item from the client; granting the first account an ownership right of the target item in response to the purchase request satisfying a purchase condition. receiving a second room switching request transmitted by the client, and transmitting the first room data to the client; and receiving a placement request transmitted by the client, and transmitting a placement instruction to the client, the placement instruction instructing the client to place the target item in the first virtual room.

According to another aspect of this application, a non-transitory computer-readable storage medium is provided, the storage medium storing a computer program, and the computer program being executed by a processor to implement the foregoing method for decorating a virtual room.

In embodiments consistent with the present disclosure, For the first virtual character displayed in the first virtual room, both the first virtual room and the first virtual character belong to the first account. The first virtual character may be controlled to enter the second virtual room in response to the first switching operation, and the corresponding purchase interface is displayed when the target item placed in the second virtual room is selected. After the first account purchase the target item through the purchase operation, the first virtual character may be controlled to return to the first virtual room and the target item may be placed in the first virtual room. By setting different virtual rooms and placing virtual items in the virtual rooms, a preview of the target item can be provided for the first account, thereby reducing time for the first account to select the target item and improving human-machine interaction efficiency. Moreover, a placement may be easily determined based on the preview, thereby effectively guiding a purchase strategy, reducing a large quantity of invalid interactions caused by purchase choices, and improving system resource response efficiency.

### BRIEF DESCRIPTION OF THE DRAWINGS

FIG. 1 is a schematic structural diagram of a terminal according to an embodiment of this application.

FIG. 2 is a structural block diagram of a computer system according to an embodiment of this application.

FIG. 3 is a schematic diagram of an interface for a method for decorating a virtual room according to an embodiment of this application.

FIG. 4 is a flowchart of a method for decorating a virtual room according to an embodiment of this application.

FIG. 5 is a flowchart of a method for decorating a virtual room according to an embodiment of this application.

FIG. 6 is a schematic diagram of an interface according to an embodiment of this application.

FIG. 7 is a schematic diagram of an interface for a method for decorating a virtual room according to an embodiment of this application.

FIG. 8 is a schematic diagram of an interface for a method for decorating a virtual room according to an embodiment of this application.

FIG. 9 is a schematic diagram of an interface for a method for decorating a virtual room according to an embodiment of this application.

FIG. 10 is a flowchart of a method for decorating a virtual room according to an embodiment of this application.

FIG. 11 is a schematic diagram of an interface for a method for decorating a virtual room according to an embodiment of this application.

FIG. 12 is a schematic diagram of an interface for a method for decorating a virtual room according to an embodiment of this application.

FIG. 13 is a schematic diagram of an interface for a method for decorating a virtual room according to an embodiment of this application.

FIG. 14 is a flowchart of a method for decorating a virtual room according to an embodiment of this application.

FIG. 15 is a flowchart of a method for decorating a virtual room according to an embodiment of this application.

FIG. 16 is a flowchart of a method for decorating a virtual room according to an embodiment of this application.

FIG. 17 is a flowchart of dividing candidate room pools according to an embodiment of this application.

FIG. 18 is a flowchart of entering a virtual room according to an embodiment of this application.

FIG. 19 is a schematic diagram of an apparatus for decorating a virtual room according to an embodiment of this application.

FIG. 20 is a schematic diagram of an apparatus for decorating a virtual room according to an embodiment of this application.

FIG. 21 is a structural block diagram of a terminal according to an embodiment of this application.

### DESCRIPTION OF EMBODIMENTS

To make the objectives, technical solutions, and advantages of this application clearer, the following further describes implementations of this application in detail with reference to the accompanying drawings.

The method provided in this application may be applied to an application with virtual rooms and virtual characters. For example, the application that supports virtual rooms may be an application where a user may control the virtual characters to move in the virtual rooms. For example, the method provided in this application may be applied to any program among virtual reality (VR) applications, augmented reality (AR) programs, three-dimensional map programs, virtual reality games, and augmented reality games.

In some embodiments, the foregoing application may be a costume game, a dress-up game, a role playing game, or the like. A client may support at least one of a Windows operating system, an Apple operating system, an Android operating system, an IOS operating system, and a LINUX operating system, and clients of different operating systems may be interconnected. In some embodiments, the foregoing client is suitable for programs on a mobile terminal with a touchscreen.

In some embodiments, the foregoing client is an application developed based on a three-dimensional engine. For example, the three-dimensional engine is a Unity engine.

The terminal in this application may be a desktop computer, a laptop portable computer, a mobile phone, a tablet computer, an e-book reader, a moving picture experts group audio layer III (MP3) player, a moving picture experts group audio layer IV (MP4) player, or the like. The client that supports virtual rooms is installed and run in the terminal. This application may be one of a virtual reality application and an augmented reality program. In some embodiments, this application may be a standalone application such as a standalone 3D game program or an on-line application.

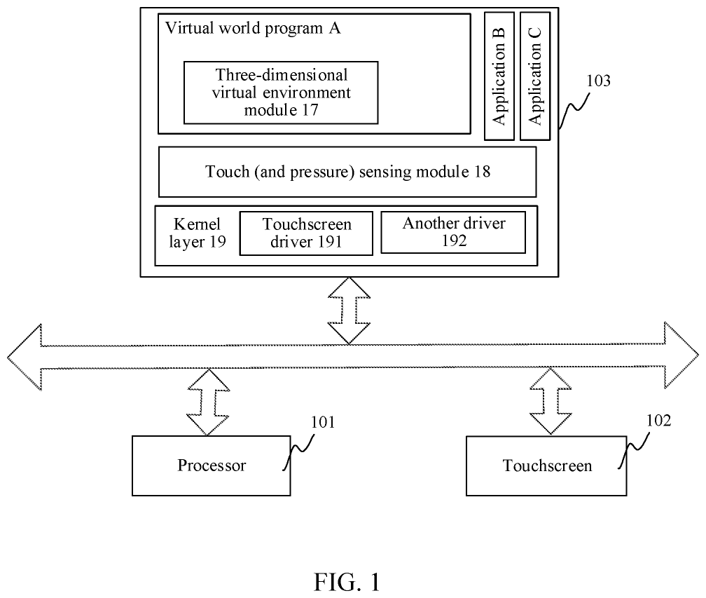

FIG. 1 is a schematic structural diagram of a terminal according to an embodiment of this application. The terminal includes a processor 101, a touchscreen 102, and a memory 103.

The processor 101 may be at least one of a single-core processor, a multi-core processor, an embedded chip, and a processor having an instruction running capability.

The touchscreen 102 includes an ordinary touchscreen or a pressure sensing touchscreen. The ordinary touchscreen may measure a press operation, or a slide operation applied to the touchscreen 102; and the pressure sensing touchscreen may measure press strength applied to the touchscreen 102.

Memory 103 stores an executable program of processor 101. For example, memory 103 may store a virtual environment program A, an application B, an application C, a touch pressure sensing module 18, and a kernel layer 19 of an operating system. The virtual environment program A is an application developed based on a three-dimensional virtual environment module 17. In some embodiments, the virtual environment program A includes but is not limited to at least one of a game program, a virtual reality program, a three-dimensional map program, and a three-dimensional demonstration program developed by the three-dimensional virtual environment module (also known as a virtual environment module) 17. For example, when the operating system of the terminal is an Android operating system, the virtual environment program A is developed in a Java programming language and a C# language. For another example, when the operating system of the terminal is an IOS operating system, the virtual environment program A is developed in an Object-C programming language and a C# language.

The three-dimensional virtual environment module 17 is a module supporting a plurality of operating system platforms. For example, the three-dimensional virtual environment module may be applied to program development in many fields such as a game development field, a virtual reality (VR) field, and a three-dimensional map field. This embodiment does not limit the present disclosure to a specific type of the three-dimensional virtual environment module 17. The three-dimensional virtual environment module 17 in the following embodiments is a module developed by using a Unity engine as an example.

The touch (and pressure) sensing module 18 is a module for receiving a touch event (and a pressure touch event) reported by a touchscreen driver 191. In some embodiments, the touch sensing module may not have a pressure sensing function and does not receive a pressure touch event. The touch event includes: a type and coordinate values of the touch event. The type of touch event includes but is not limited to a touch start event, a touch movement event, and a touch drop event. The pressure touch event includes: a pressure value and coordinate values of the pressure touch event. The coordinate values are used for indicating a touch position of a pressure touch operation on the display screen. In some embodiments, an abscissa axis is set up in a horizontal direction of the display screen and an ordinate axis is set up in a vertical direction of the display screen to obtain a two-dimensional coordinate system.

For example, the kernel layer 19 includes a touchscreen driver 191 and another driver 192. The touchscreen driver 191 is a module for detecting the pressure touch event. After detecting the pressure touch event, the touchscreen driver 191 transmits the pressure touch event to the pressure sensing module 18.

Another driver 192 may be a driver related to the processor 101, a driver related to the memory 103, a driver related to a network component, a driver related to a sound component, or the like.

A person skilled in the art may learn that the above is only schematic for the structure of the terminal. In different embodiments, the terminal may have more or fewer components. For example, the terminal may further include a gravity acceleration sensor, a gyroscope sensor, a power supply, and the like.

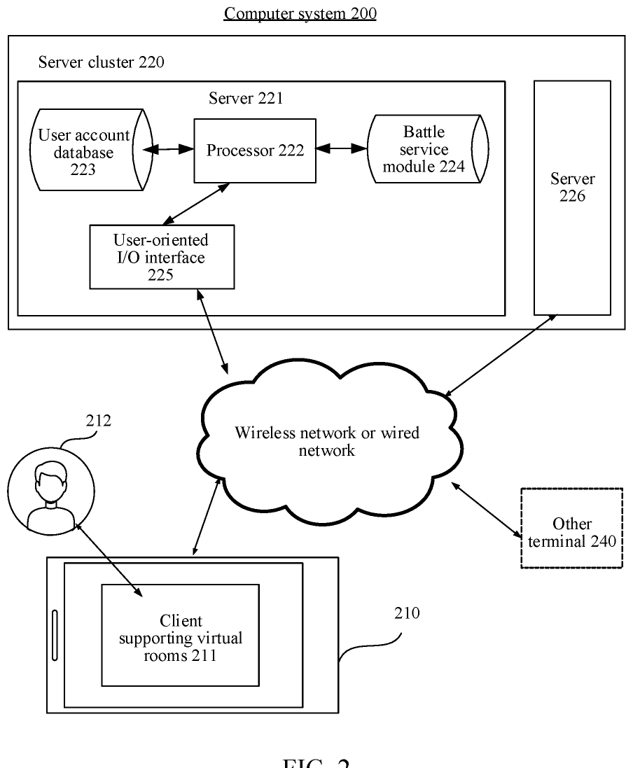

FIG. 2 shows a structural block diagram of a computer system according to an embodiment of this application. The computer system 200 includes: a terminal 210 and a server cluster 220.

The terminal 210 is installed with and runs a client 211 supporting virtual rooms, and the client 211 may be an application that supports virtual rooms. Client 211 may be an application that supports social functions and virtual rooms. The social functions are functions in forms of instant messaging, microblog, blog, official account, on-line meeting, live streaming, and the like based on a network.

When the terminal runs client 211, a screen of the terminal 210 displays a user interface of the client 211. The terminal 210 is a terminal used by a first user 212. The first user 212 uses terminal 210 to control a first virtual character in a virtual room to carry out activities. The first virtual character may be referred to as the first virtual character of the first user 212. The activities of the first virtual character include but are not limited to: at least one of adjusting body posture, crawling, walking, running, jumping, and picking up. For example, the first virtual character is, for example, a simulated character or a cartoon character.

A device type of terminal 210 includes: at least one of a smart phone, a tablet computer, an e-book reader, an MP3 player, an MP4 player, a laptop portable computer, and a desk computer.

FIG. 2 shows only one terminal, but there is a plurality of other terminals 240 in different embodiments. In some embodiments, there is alternatively at least one other terminal 240 corresponding to a developer. A development and editing platform for a virtual environment client is installed on the other terminal 240. The developer may edit and update the client on the other terminal 240, and transmit an updated client installation package to the server cluster 220 through a wired or wireless network. The terminal 210 may download the client installation package from the server cluster 220 to update the client.

The terminal 210 and the other terminal 240 are connected to the server cluster 220 through a wireless network or a wired network.

The server cluster 220 includes at least one of a server, a plurality of servers, a cloud computing platform, and a virtualization center. The server cluster 220 is configured to provide back-end services for the client that supports the three-dimensional virtual environment. In some embodiments, the server cluster 220 undertakes primary computing work, while the terminal undertakes secondary computing work; alternatively, the server cluster 220 undertakes secondary computing work, while the terminal undertakes primary computing work; and alternatively, the server cluster 220 and the terminal perform collaborative computations by using a distributed computing architecture.

In some embodiments, the forgoing terminal and server are both computing devices.

In a schematic example, the server cluster 220 includes server 221 and a server 226. The server 221 includes a processor 222, a user account database 223, a battle service module 224, and a user-oriented input/output interface (I/O interface) 225. The processor 222 is configured to load instructions stored in server 221, and process data in the user account database 223 and the battle service module 224. The user account database 223 is configured to store data of user accounts used by the terminal 210 and the other terminal 240, such as avatars of the user accounts, nicknames of the user accounts, battle effectiveness indexes of the user accounts, and serving areas where the user accounts are located. The battle service module 224 is configured to provide a plurality of battle rooms for user battling. The user-oriented I/O interface 225 is configured to build communication and exchange data with terminal 210 through the wireless network or wired network.

Based on the foregoing introduction about the virtual environment and the foregoing explanation of the implementation environment, the following will explain a method for decorating a virtual room according to some embodiments of this application.

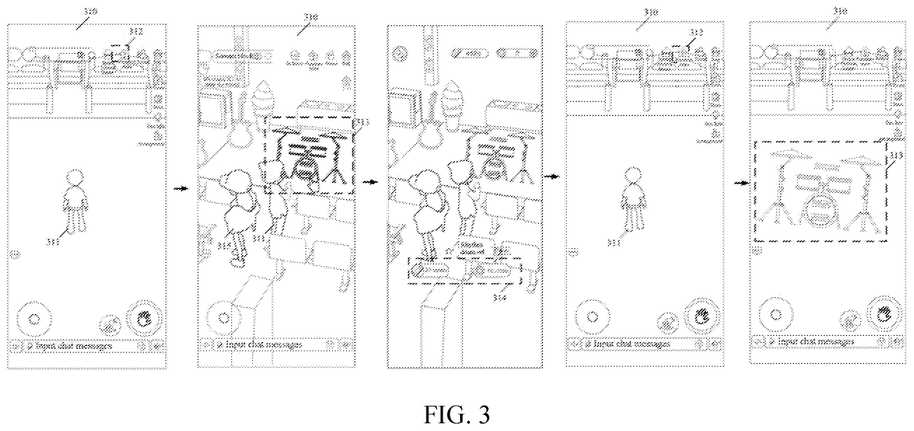

FIG. 3 shows a schematic diagram of an interface for a method for decorating a virtual room according to an embodiment of this application.

A display interface 310 of a first account displays a first virtual room and a first virtual character 311 in the first virtual room. The first virtual room and the first virtual character 311 belong to the first account.

The first account may control the first virtual character 311 to move in a second virtual room 310. For example, a player who logs into the first account may control the movement of the first virtual character 311 through a joystick.

In response to a first switching operation of entering the second virtual room, the second virtual room is displayed in the display interface 310. In some embodiments, the display interface 310 displays a room switching control 312. The first account performs the first switching operation in the room switching control 312, and controls the first virtual character 311 to enter the second virtual room while displaying the second virtual room.

The second virtual room does not belong to the first account, and at least one virtual item is placed in the second virtual room. The second virtual room is a three-dimensional virtual room constructed based on a three-dimensional virtual environment, and is used for simulating a virtual room in a world such as a real world, a magical world, an imaginary world, or a metaverse world.

In some embodiments, the second virtual room may be a virtual room selected independently by the first account or a sample virtual room. For example, the second virtual room is a sample virtual room provided by a back-end system, and the sample virtual room is determined according to preferences of the first account.

For example, the virtual item refers to a virtual object that exists in the second virtual room and can be commercialized. For example, the virtual item includes but is not limited to one or more of display areas of virtual items, virtual furniture, virtual pets, virtual appliances, virtual clothing, virtual plants, virtual food, virtual travel tools, virtual house models, virtual raw materials, virtual semi-finished products, virtual devices, and virtual services.

For example, the second virtual room is a virtual supermarket in which various virtual items such as virtual daily necessities, virtual food, virtual appliances, and virtual clothing are placed; the second virtual room is a virtual sales department in which multiple house models are placed; the second virtual room is a virtual car dealer in which multiple virtual items such as virtual cars, virtual electric vehicles, and virtual skateboards are placed; or the second virtual room is a virtual bedroom in which virtual items such as a single bed, a virtual wardrobe, a virtual dressing table, a virtual mirror, a virtual sofa, a virtual television, and a virtual desk lamp are placed.

With reference to FIG. 3, the second virtual room includes a plurality of virtual items. The target item is a virtual drum set 313 as an example below.

A purchase interface 314 for the virtual drum set 313 is displayed in response to a selection operation on the virtual drum set 313. For example, a player clicks an area where the virtual drum set 313 is located, and the purchase interface 314 is displayed below the virtual drum set 313.

In some embodiments, the purchase interface 314 displays at least one of an item name of the virtual drum set 313, a quantity of purchase resources, and an ownership of the virtual drum set 313 by the first account.

In some embodiments, the display interface 310 also displays an optional item configuration for the virtual drum set 313. The player performs a selection operation on the optional item configuration to change item parameters of the virtual drum set 313, the item parameters including at least one of color, style, model, size, and material. For example, the player selects reddish brown as the color of the virtual drum set 313.

The virtual drum set 313 is obtained as a virtual item owned by the first account in response to a purchase operation on the purchase interface 314. For example, the player logs into the first account. The player clicks an obtaining button on the purchase interface 314 to determine the virtual drum set 313 as a virtual item owned by the first account.

In some embodiments, the second virtual room further displays a second virtual character 315 controlled by a homeowner account. The homeowner account is an owner account of the second virtual room, and the second virtual character 315 may be considered as a virtual owner of the second virtual room 310. The first account and the homeowner account may interact for the virtual drum set 313, and chat information of interaction between the first virtual character 313 and the second virtual character 315 for the virtual drum set 313 in the second virtual room may be displayed in the display interface 310 in response to a control operation on the first virtual character 313.

Similarly, a third virtual character (not shown) controlled by a fourth account may be in some embodiments displayed in the second virtual room, where the fourth account is a visitor account that enters the second virtual room. For the virtual drum set 313, chat information of interaction between the first virtual character 313 and the third virtual character for the virtual drum set 313 in the second virtual room may also be displayed in the display interface 310.

For example, the first virtual character 311 is controlled to return to the first virtual room in response to a second switching operation of returning to the first virtual room. Subsequently, the target item is placed in the first virtual room in response to a placement operation on the target item.

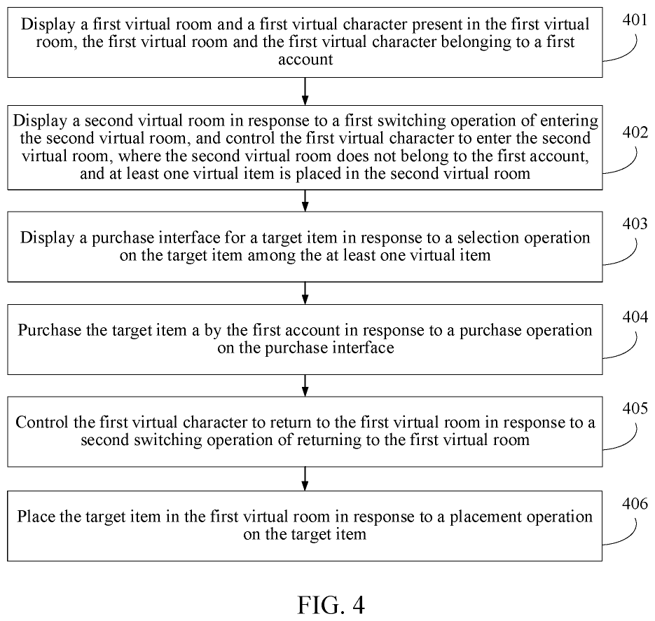

FIG. 4 shows a flowchart of a method for decorating a virtual room according to an embodiment of this application. This method is applied to a terminal that logs into a first account. This method includes the following steps:

Step 401: Display the first virtual room and a first virtual character present in the first virtual room.

For example, the first virtual room and the first virtual character belong to the first account.

Step 402: Display a second virtual room in response to a first switching operation of entering the second virtual room, and control the first virtual character to enter the second virtual room.

For example, the second virtual room does not belong to the first account, and at least one virtual item is placed in the second virtual room.

The second virtual room may be a virtual room selected independently by the first account or a sample virtual room. For example, the second virtual room is a sample virtual room provided by a back-end system, and the sample virtual room is determined according to historical data of the first account. For example, the first account selects a virtual room independently from a plurality of candidate virtual rooms, and the virtual room selected by the first account is determined as the second virtual room.

For example, the virtual item refers to a virtual object that exists in the second virtual room and can be commercialized. For example, the virtual item is one or more of virtual furniture, virtual pets, virtual appliances, virtual clothing, and virtual plants.

The virtual item may be customized and set by a homeowner account that owns the second virtual room. For example, the second virtual room is a virtual room customized by a second account that has a friend relationship with the first account, and the virtual item placed in the second virtual room is customized by the second account. For another example, the second virtual room is a sample virtual room provided by the back-end system, and a placement location of the virtual item in the second virtual room is defaulted.

For example, the first switching operation is used for implementing display switching between the first virtual room and the second virtual room. In some embodiments, in response to the first switching operation on the room switching control, the display of the first virtual room is cancelled, and the second virtual room is displayed.

Step 403: Display a purchase interface for a target item in response to a selection operation on the target item among at least one virtual item.

For example, the selection operation on the target item includes but is not limited to at least one of the following operations: a click operation on the target item, a double-click operation on the target item, a touch operation on the target item, a slide operation on the target item, and a movement operation close to the target item.

With reference to FIG. 3, the target item is a virtual drum set 313 as an example. In response to the click operation on the virtual drum set 313, the purchase interface 314 for the virtual drum set 313 is displayed. A quantity of the purchase interface 314 may be determined according to specific requirements. FIG. 3 shows two purchase interfaces 314, indicating two different purchase ways for the virtual drum set 313.

In some embodiments, the purchase ways for the target item include but are not limited to at least one of the following: purchase using virtual resources, purchase using virtual vouchers, purchase by completing assigned tasks, and purchase by accepting gifts from friend accounts.

Step 404: Obtain the target item as a virtual item owned by the first account in response to a purchase operation on the purchase interface.

For example, the purchase operation on the purchase interface includes but is not limited to at least one of the following operations: a click operation on the purchase interface, a double-click operation on the purchase interface, a touch operation on the purchase interface, and a slide operation on the purchase interface.

With reference to FIG. 3, the first account performs a click operation on the purchase interface 314 to obtain the virtual drum set 313 as the target item owned by the first account. A virtual purchase currency or virtual purchase voucher corresponding to the first account is correspondingly reduced, and a reduced quantity is equivalent to a virtual value of the virtual drum set 313.

Step 405: Control the first virtual character to return to the first virtual room in response to a second switching operation of returning to the first virtual room.

For example, the second switching operation is used for implementing display switching between the first virtual room and the second virtual room. In some embodiments, in response to the second switching operation on the room switching control, the display of the second virtual room is cancelled, and the first virtual room is displayed.

Step 406: Place the target item in the first virtual room in response to a placement operation on the target item.

After the first virtual character is controlled to return to the first virtual room, the placement operation is performed on the target item to place the target item in the first virtual room.

A placement location of the target item in the first virtual room may be either a specified location or a default position, the specified location is a position specified for placement in the first virtual room, and the default position is a placement location of the target item in the second virtual room.

To sum up, for the first virtual character displayed in the first virtual room, both the first virtual room and the first virtual character belong to the first account. The first virtual character may be controlled to enter the second virtual room in response to the first switching operation, and the corresponding purchase interface is displayed when the target item placed in the second virtual room is selected. After the first account purchases the target item through the purchase operation, the first virtual character may be controlled to return to the first virtual room and the target item is placed in the first virtual room. By setting different virtual rooms and placing virtual items in the virtual rooms, a preview of the target item can be provided for the first account, thereby reducing time for the first account to select the target item and improving human-machine interaction efficiency. Moreover, a placement may be easily determined based on the pr, thereby effectively guiding a purchase strategy, reducing a large quantity of invalid interactions caused by purchase choices in related technologies, and improving system resource response efficiency.

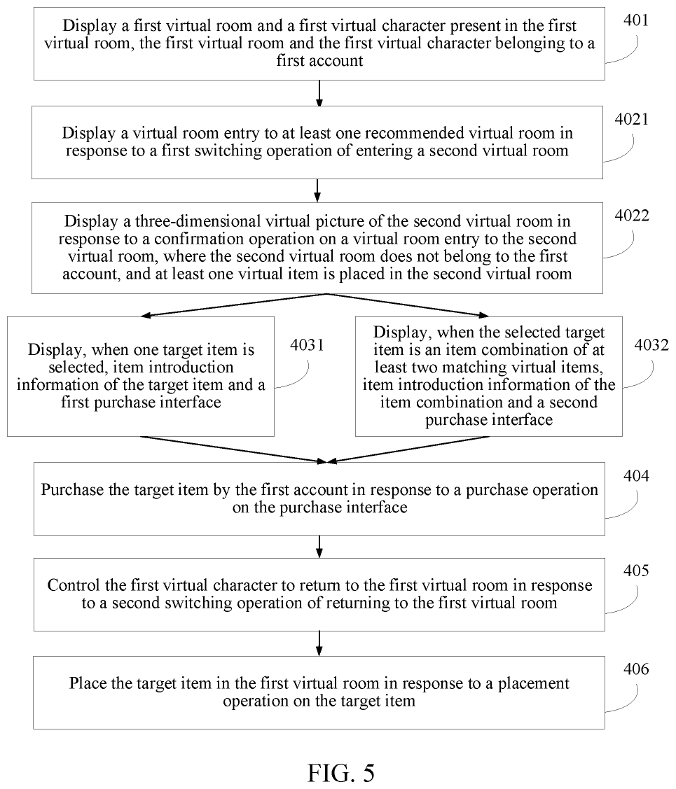

Based on FIG. 4, FIG. 5 shows a flowchart of a method for decorating a virtual room according to an embodiment of this application. This method is applied to a terminal that logs into a first account. Step 402 is about displaying a second virtual room in response to a first switching operation of entering the second virtual room. This embodiment explains how to determine the first switching operation. The determination of the first switching operation may be implemented as steps 4021 and 4022, and step 403 may be implemented as one of steps 4031 and 4032, as follows:

Step 4021: Display a virtual room entry to at least one recommended virtual room. The second virtual room is one of the at least one recommended virtual room.

In some embodiments, the at least one recommended virtual room includes at least one of the following three types of virtual rooms:

### Sample Virtual Room Provided by a Back-End System or Public Account.

For example, the public account is an account that provides information push services to at least one account. For example, the at least one recommended virtual room is a sample virtual room provided by the back-end system or public account, where the back-end system or public account determines the recommended virtual room according to choice preferences of the first account.

### Virtual Room Customized by the Second Account.

For example, the second account and the first account have a friend relationship in an instant messaging system or virtual world. For example, at least one recommended virtual room is a virtual room customized by the second account. The first account and the second account are friends in the instant messaging system. The second account arranges a wall lamp, a wooden bed, a ceiling crystal lamp, a carpet, and the like in the virtual room according to its preferences. The virtual room may be used as one of the at least one recommended virtual room.

### Virtual Room Customized by a Third Account.

For example, the third account and the first account do not have a friend relationship in the instant messaging system or virtual world. For example, if at least one recommended virtual room is a virtual room customized by the third account, the first account and the third account do not have a friend relationship in the virtual world. The third account arranges the virtual room according to its preferences, and the virtual room may be used as one of the at least one recommended virtual room.

In some embodiments, virtual rooms may alternatively be divided from the following dimensions:

1. According to a dimension about whether a homeowner account is on-line, virtual rooms may be divided into homeowner account on-line virtual rooms and homeowner account off-line virtual rooms.

In a case that a homeowner account owns a plurality of virtual rooms, a room combination including at least two virtual rooms among the plurality of virtual rooms may alternatively be divided into a virtual room where a virtual character controlled by the homeowner account is present, and a virtual room where the virtual character is not present.

For example, the homeowner account owns 5 bedrooms and 2 living rooms, of which 2 bedrooms and 1 living room constitute a combination. For example, the virtual character controlled by the homeowner account is present in a living room, the 2 bedrooms may be divided into virtual rooms where the virtual character controlled by the homeowner account are not present, and the living room may be divided into a virtual room where the virtual character controlled by the homeowner account is present.

2. According to a dimension about whether virtual characters controlled by a friend account are present in virtual rooms, the virtual rooms may be divided into friend present rooms and friend absent rooms.

According to a quantity of virtual characters controlled by the friend account, a most friend room may be further determined from the friend present rooms.

For example, virtual room 1 displays virtual character 1, virtual character 2, and virtual character 3, virtual character 1 and virtual character 2 have a friend relationship with the first account, and virtual room 1 may be divided into a friend present room. For another example, virtual room 1 displays virtual character 1, virtual character 2, and virtual character 3, virtual room 2 displays virtual character 4 and virtual character 5, and virtual room 3 displays virtual character 6; virtual character 1, virtual character 2, and virtual character 5 have a friend relationship with the first account, and other virtual characters have no friend relationship with the first account; and virtual room 1 and virtual room 2 may be divided into friend present rooms, virtual room 3 is divided into a friend absent room, and virtual room 1 is a most friend room.

3. According to a dimension about whether virtual characters controlled by a visitor account are present in virtual rooms, the virtual rooms may be divided into somebody present rooms and nobody present rooms.

According to a quantity of virtual characters controlled by the visitor account, a most person room may be further determined from somebody present rooms.

In some embodiments, the visitor account may be an account that has a friend relationship with the first account, or a stranger account that has no friend relationship with the first account.

When the visitor account is an account that has a friend relationship with the first account, the division of virtual rooms may refer to the division dimension of the second account.

When the visitor account is a stranger account, the virtual rooms may be specifically divided into stranger present rooms and stranger absent rooms. Assuming that virtual room 1 displays virtual character 1 and virtual character 2, virtual room 2 displays virtual character 3, and virtual character 1, virtual character 2, and virtual character 3 are all virtual characters controlled by the stranger account, virtual room 1 and virtual room 2 may be divided into stranger present rooms, and virtual room 1 is a most stronger room.

It is to be understood that divisions of virtual rooms according to relevant dimensions of accounts fall within the scope of protection of this application. The foregoing content is only an example and does not impose specific limitations on this application.

Step 4022: Determine to obtain the first switching operation in response to the virtual room entry to the second virtual room being selected. At this time, step 402 may be performed to display the second virtual room.

For example, the second virtual room is one of the at least one recommended virtual room, and at least one virtual item is placed in the second virtual room.

A confirmation operation on the virtual room entry includes but is not limited to at least one of the following operations: a click operation on the virtual room entry, a double-click operation on the virtual room entry, a touch operation on the virtual room entry, and a slide operation on the virtual room entry.

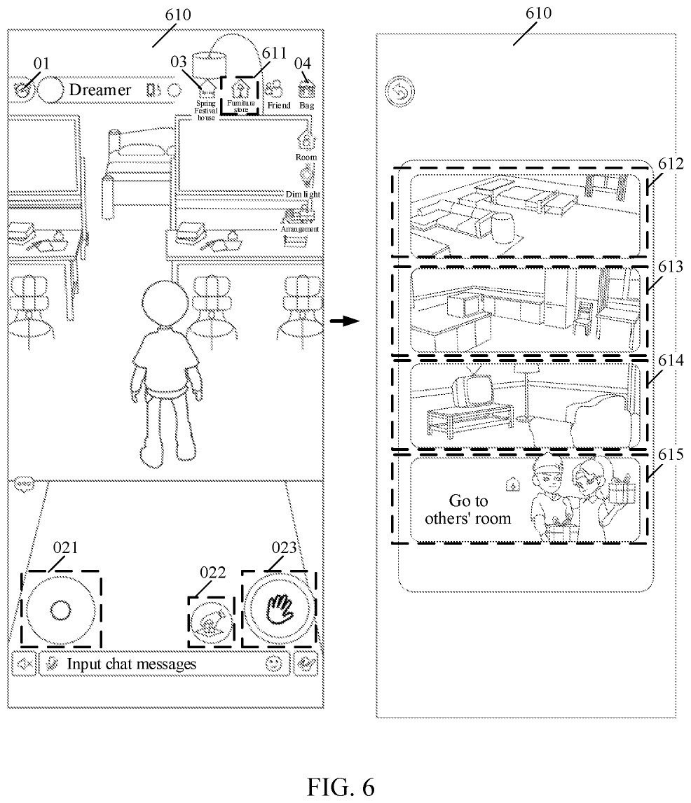

FIG. 6 shows a schematic diagram of an interface according to an embodiment of this application. A display interface 610 of a first account displays a selection control 611. A first virtual room entry 612, a second virtual room entry 613, a third virtual room entry 614, and another virtual room entry 615 are displayed in response to a trigger operation of the first account on the selection control 611. The four virtual room entries correspond to four different recommended virtual rooms.

The recommended virtual rooms corresponding to the first virtual room entry 612, the second virtual room entry 613, and the third virtual room entry 614 are sample virtual rooms provided by a back-end system or public account; and the recommended virtual room corresponding to another virtual room entry 615 includes a virtual room customized by a second account and/or a virtual room customized by a third account.

In some embodiments, in response to a confirmation operation on another virtual room entry 615, the virtual room customized by the second account, or the virtual room customized by the third account is randomly displayed.

In some embodiments, the display interface 610 also displays a nickname string “Dreamer” of the first account, and the virtual rooms displayed in the display interface 610 are owned by the first account.

In some embodiments, the display interface 610 also displays a menu control 01. In response to a trigger operation on the menu control 01, the display interface 610 is switched to display as a management interface of the first account.

In some embodiments, the display interface 610 also displays at least one of a first operation control 021, a second operation control 022, and a third operation control 023.

In response to a control operation on the first operation control 021, a first virtual character is controlled to move in a second virtual room; in response to a control operation on the second operation control 022, the first virtual character is controlled to pick up a selected virtual item, where the virtual item may be a purchased target item, a randomly dropped virtual item, or a virtual item dropped by the first virtual character; and in response to a control operation on the third operation control 023, the first virtual character is controlled to take out a target item placed in a virtual backpack, for example, the first account places a virtual carpet purchased from another virtual room in its virtual room through the control operation on the third operation control 023.

In some embodiments, the display interface 610 also displays a public room switching control 03, and a virtual public room is displayed in response to a trigger operation on the public room switching space 03. The arrangement of the virtual public room may be set according to specific requirements. The virtual public room may display virtual characters controlled by a plurality of accounts, and the plurality of accounts may purchase virtual items in the virtual public room at the same time.

For example, the virtual public room is arranged according to a Spring Festival theme. The first account clicks the public room switch control 03, and the virtual public room is displayed in the display interface 610. The virtual public room is arranged with virtual Chinese knots, virtual lucky stickers, virtual Spring Festival couplets, virtual lanterns, virtual tiger head symbols, and the like.

In some embodiments, the display interface 610 also displays a backpack control 04, a virtual backpack is displayed in response to a trigger operation on the backpack control 04, and the virtual backpack displays at least one target item owned by the first account.

The menu control 01, the first operation control 021, the second operation control 022, the third operation control 023, the public room switching control 03, and the backpack control 04 may be hidden controls, and the controls are displayed in accordance with display conditions and hidden in accordance with hide conditions.

For example, at least one of the menu control 01, the first operation control 021, the second operation control 022, the third operation control 023, the public room switching control 03, and the backpack control 04 is displayed in response to a trigger operation on the display interface 610; and The display of the menu control 01, the first operation control 021, the second operation control 022, the third operation control 023, the public room switching control 03, and the backpack control 04 is canceled in a case that the display time of the menu control 01, the first operation control 021, the second operation control 022, the third operation control 023, the public room switching control 03, and the backpack control 04 exceeds preset time.

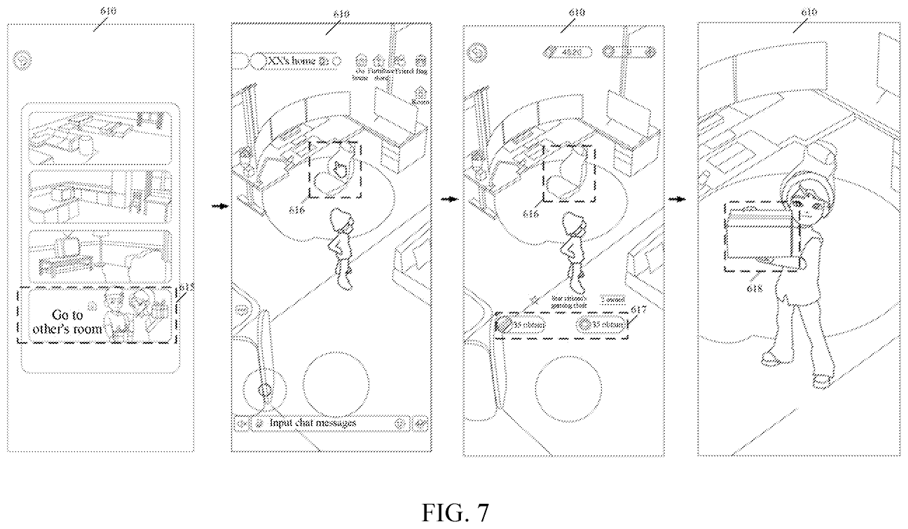

FIG. 7 shows a schematic diagram of an interface for a method for decorating a virtual room according to an embodiment of this application. A virtual room customized by the second account is displayed in response to a confirmation operation on another virtual room entry 615. Subsequently, a purchase interface 617 for a virtual chair 616 is displayed in response to a selection operation on the virtual chair 616. The virtual chair 616 is obtained as a target item owned by the first account in response to a purchase operation on the purchase interface 617.

After the virtual chair 616 is obtained as the target item owned by the first account, a special obtaining effect may be displayed in the display interface 610, where the effect may be a packaging animation to indicate that the first account owns the virtual chair 616. In some embodiments, after the virtual chair 616 is successfully obtained as the target item owned by the first account, a virtual item bag 618 may be displayed in the display interface, the virtual item bag 618 being used for indicating packaging of the virtual chair 616.

In some embodiments, the second virtual room belongs to a target room combination, and the target room combination includes at least two virtual rooms. The second virtual room is a virtual room where the second virtual character controlled by the homeowner account is present in the target room combination, or the second virtual room is a virtual room with most third virtual characters controlled by the visitor account in the target room combination.

For example, if the target room combination is owned by the second account and includes 3 bedrooms and 1 living room, and the second virtual character controlled by the second account is located in a master bedroom, the second virtual room is the master bedroom of the target room combination.

For example, if the target room combination has third virtual characters controlled by the visitor account, and most third virtual characters are in the living room, the second virtual room is the living room in the target room combination.

Step 4031: Display, when one target item is selected, item description of the target item and a first purchase interface.

For example, the item description includes at least one of an item name, a quantity of purchase resources, and an ownership of the target item by the first account.

The purchase resources refer to virtual resources and/or virtual purchase vouchers that the first account needs to pay to obtain the selected target item. For example, the purchase resources are virtual resources, and a quantity of virtual resources required to purchase the target item is displayed on the periphery of the selected target item.

In some embodiments, the item description is displayed on the periphery of the first purchase interface.

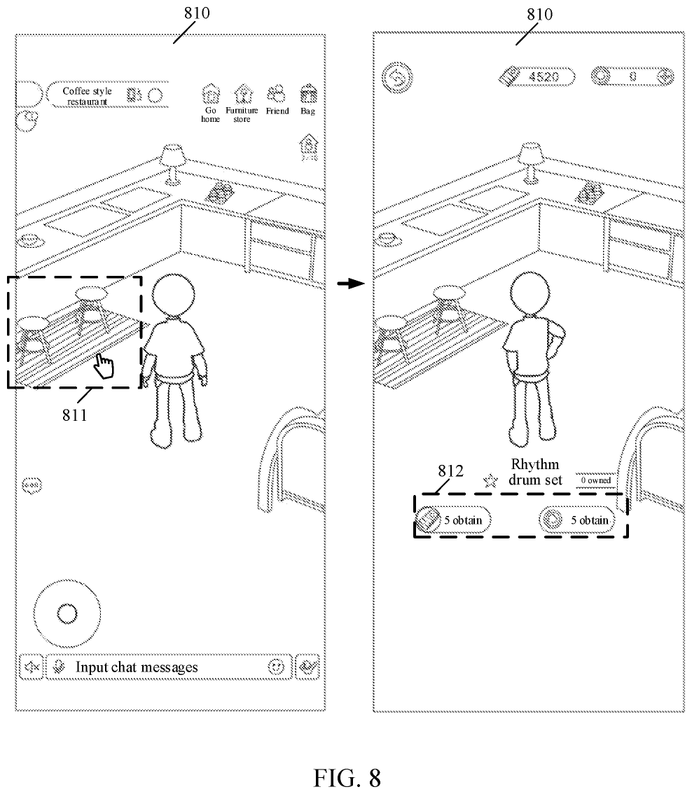

FIG. 8 is a schematic diagram of an interface for a method for decorating a virtual room according to an embodiment of this application. A display interface 810 displays a second virtual room, and a virtual carpet 811 is placed in the second virtual room. In a case that the selected target item is the virtual carpet 811, the display interface 810 displays item description of the virtual carpet 811 and two first purchase interfaces 812.

The item description of the virtual carpet 811 is displayed on the upper side of the first purchase interfaces 812, the item description including a name of the virtual carpet 811 and a quantity of the virtual carpet 811 owned by the first account. In addition, the two first purchase interfaces 812 are used for indicating two different purchase ways, and a quantity of purchase resources for the virtual carpet 811 is further displayed on the periphery of the two first purchase interfaces 812.

In some embodiments, to meet different requirements of the first account for the target item, the method for decorating a virtual room according to the embodiments of this application further includes:
displaying an optional item configuration for the target item; and
changing item parameters of the target item in response to a selection operation on the optional item configuration, the item parameters including at least one of color, style, model, size, and material.

The optional item configuration is used for indicating that the first account may independently select the items parameters configured for the target item. The target item is the virtual carpet 811 as an example. When the first account performs a selection operation on the virtual carpet 811, the optional item configuration may be displayed on the periphery of the virtual carpet 811, and the first account may perform the selection operation on the optional item configuration. For example, the first account changes the color of the virtual carpet 811 to beige.

In some embodiments, the display interface 810 also displays a name string of the second virtual room, where the name string may be a string “Coffee style restaurant”.

Step 4032: Display, when the selected target item is an item combination of at least two matching target items, item description of the item combination and a second purchase interface.

For example, the item description includes at least one of an item name, a quantity of purchase resources, and an ownership of the target item by the first account.

The item description is displayed on the periphery of the second purchase interface.

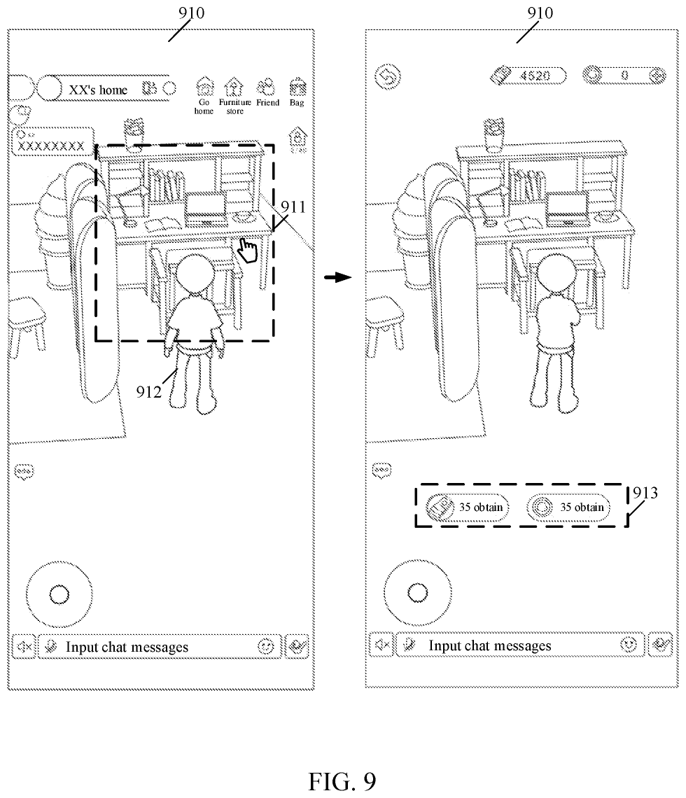

FIG. 9 is a schematic diagram of an interface for a method for decorating a virtual room according to an embodiment of this application. A display interface 910 displays a second virtual room, a virtual combination desk 911 is placed in the second virtual room, and the virtual combination desk 911 includes two target items, namely, a virtual desk and a virtual chair. In a case that the selected target item is the virtual combination desk 911, the display interface 910 displays item description of the virtual combination desk 911 and two second purchase interfaces 913.

The item description of the virtual combination desk 911 is displayed on the upper side of the second purchase interfaces 913, the item description including a name of the virtual combination desk 911 and a quantity of the virtual combination desk 911 owned by the second account.

In addition, the two second purchase interfaces 913 are used for indicating two different purchase ways, and a quantity of purchase resources for the virtual combination desk 911 is further displayed on the periphery of the two second purchase interfaces 913. Assuming that the purchase resources for the virtual desk are 20 virtual resources and the purchase resources for the virtual chair are 5 virtual resources, the quantity of purchase resources for the virtual combination desk 911 is 35 virtual resources.

In some embodiments, the display interface 910 also displays a name string of the second virtual room, where the name string may be a string “XX's home”.

In some embodiments, to meet different requirements of the first account for the target item, the method for decorating a virtual room according to the embodiments of this application further includes:
displaying an optional item configuration for the target item; and
changing item parameters of the target item in response to a selection operation on the optional item configuration, the item parameters including at least one of color, style, model, size, and material.

Related descriptions of the optional item configuration and the items parameters may refer to the previous content and will not be repeated.

For example, either step 4031 or step 4032 is performed, and they cannot be performed simultaneously.

To sum up, in the method for decorating a virtual room according to this embodiment, a virtual room entry to at least one recommended virtual room is provided for the first account to select a virtual room, and the first account can quickly enter the required virtual room according to its needs to obtain the target item placed in the virtual room.

The recommended virtual rooms may be sample virtual rooms provided by the back-end system or public account, or virtual rooms customized by the second account or the third account. According to different recommended virtual rooms, the first account can obtain virtual rooms of different arrangement styles, whereby the first account is provided with a choice of virtual rooms and human-machine interaction efficiency is improved.

In some embodiments, the display content in the display interface varies depending on the quantity of selected target items.

When one target item is selected, item description of the single target item is displayed. When a plurality of target items are selected, item description of the item combination is displayed, so that the first account can intuitively obtain relevant information of the combined item, which is closer to the shopping experience in virtual reality.

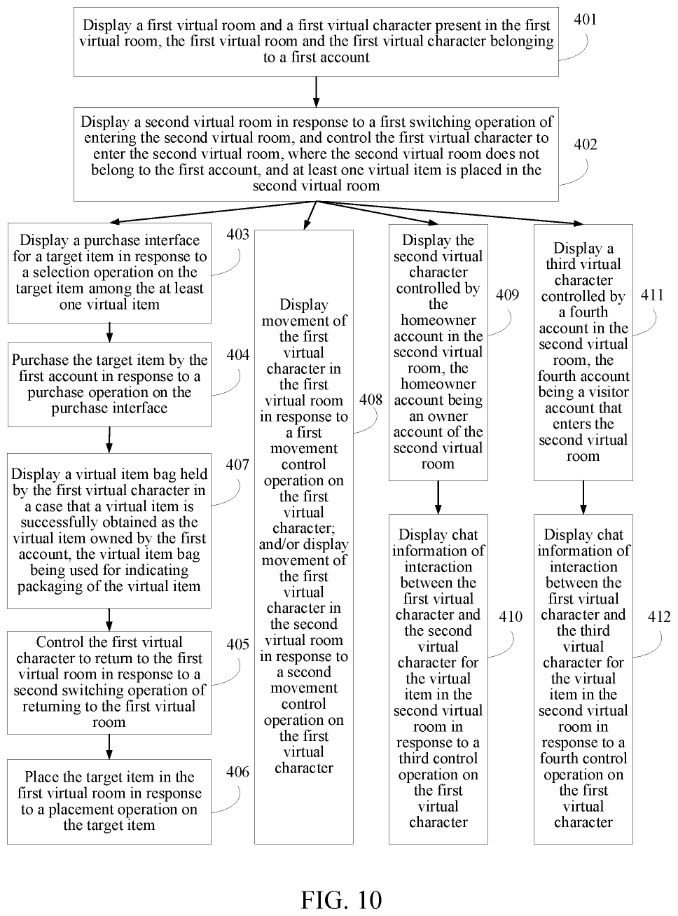

Based on FIG. 4, FIG. 10 shows a flowchart of a method for decorating a virtual room according to an embodiment of this application. This method is applied to a terminal that logs into a first account. The method further includes step 407, as follows:

Step 407: Display a virtual item bag held by the first virtual character in a case that the target item is successfully obtained as the virtual item owned by the first account.

For example, the virtual item bag is used for indicating packaging of the target item.

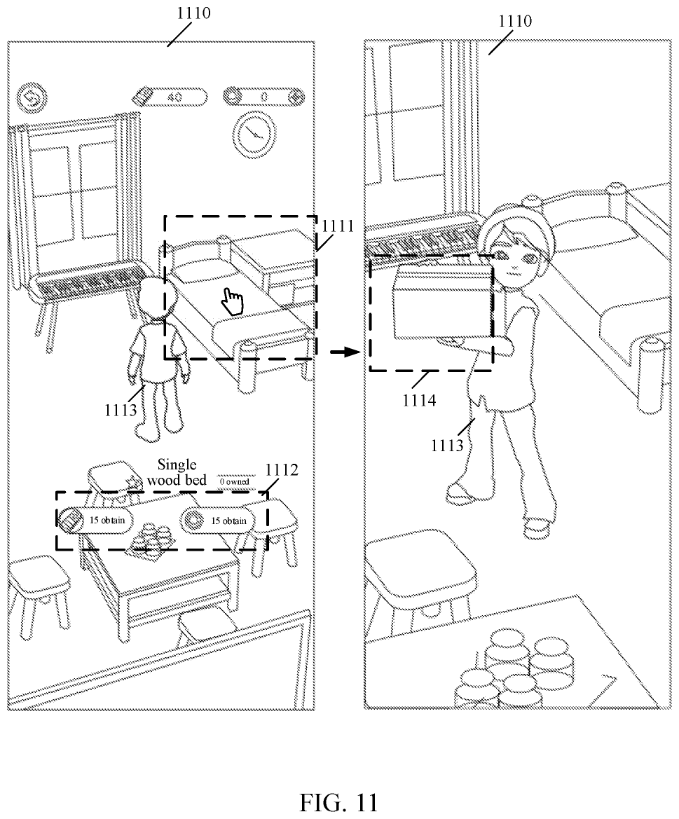

FIG. 11 shows a schematic diagram of an interface for a method for decorating a virtual room according to an embodiment of this application.

In a display interface 1110, a virtual single bed 1111 is displayed in a second virtual room, and a purchase interface 1112 for the virtual single bed 1111 is displayed in response to a selection operation on the virtual single bed 1111. Subsequently, the virtual single bed 1111 is obtained as a target item owned by the first account in response to a purchase operation on the purchase interface 1112.

In some embodiments, a first virtual character 1113 is also displayed in the second virtual room.

In a case that the virtual single bed 1111 is successfully obtained as the virtual item owned by the first account, the first virtual character 1113 holding a virtual item bag 1114 is displayed in the display interface 1110. The virtual item bag 1114 may be displayed in the form of an express box, a packaging bag, a handbag, or a packaging box.

In some embodiments, a packaging animation may also be displayed before the virtual item bag 1114 is displayed. For example, in the case that the virtual single bed 1111 is successfully obtained as the virtual item owned by the first account, the first virtual character 1113 is changed from back display to front display, and the packaging animation is displayed on the hands of the first virtual character 1113. Subsequently, the virtual item bag 1114 is displayed on the hands of the first virtual character 1113 to indicate that the virtual single bed 1111 has been packaged.

In some embodiments, with reference to FIG. 10, in the case that the first virtual character is displayed in the second virtual room, the method for decorating a virtual room according to this embodiment further includes steps 408-412. After step 4031, one of steps 4032, 408, 409, and 411 may be performed, or they are performed in order or out of order. Steps 408-412 are as follows:

Step 408: Display movement of the first virtual character in the first virtual room in response to a first movement control operation on the first virtual character; or display movement of the first virtual character in the second virtual room in response to a second movement control operation on the first virtual character.

The first movement control operation and the second movement control operation include but are not limited to at least one of the following operations: a translation operation, a turning operation, a jump operation, and a prone operation. With reference to FIG. 9, in the display interface 910, a first virtual character 912 is displayed in the second virtual room, and the first virtual character 912 is controlled by the first account.

The player who logs into the first account may control the first virtual character 912 to move in the second virtual room through the joystick; or the player who logs into the first account may control the movement of the first virtual character 912 by moving a mouse.

In the case that the first virtual character is displayed in the second virtual room, step 403 may be implemented as follows:
displaying the purchase interface for the target item in response to a click operation on the target item;
or
displaying the purchase interface for the target item in response to the distance between the first virtual character and the target item being less than a threshold.

The threshold may be customized according to specific requirements, or the threshold is a default fixed value.

For example, the first account controls the first virtual character to move towards the target item, and the purchase interface for the target item is displayed in a case that the distance between the first virtual character and the target item is less than the default fixed value.

Still refer to FIG. 9. The target item is the virtual combination desk 911, the player clicks the virtual combination desk 911, and the purchase interface 913 for the virtual combination desk 911 is displayed in response to the click operation on the virtual combination desk 911; or the player controls the first virtual character 912 to move in the second virtual room to gradually approach the virtual combination desk 911, and the purchase interface 913 is displayed in a case that the distance between the first virtual character 912 and the virtual combination desk 911 is less than the threshold.

In some embodiments, the method for decorating a virtual room further includes: displaying usage or experience of the target item by the first virtual character in the second virtual room in response to a second control operation on the first virtual character.

The second control operation refers to a control operation performed on the first virtual character about the usage or experience of the target item.

For example, with reference to FIG. 11, the target item is the virtual single bed 1111, and the first account controls the first virtual character 1113 to move to the vicinity of the virtual single bed 1111. Subsequently, the first account controls the first virtual character 1113 to lie on the virtual single bed 1111 for an experience.

Step 409: Display a second virtual character controlled by a homeowner account in the second virtual room.

For example, the homeowner account is an owner account of the second virtual room.

Step 410: Display chat information of interaction between the first virtual character and the second virtual character for the target item in the second virtual room in response to a third control operation on the first virtual character.

The third control operation refers to a control operation of the first virtual character about interaction for the homeowner account, and includes but is not limited to triggering a chat control.

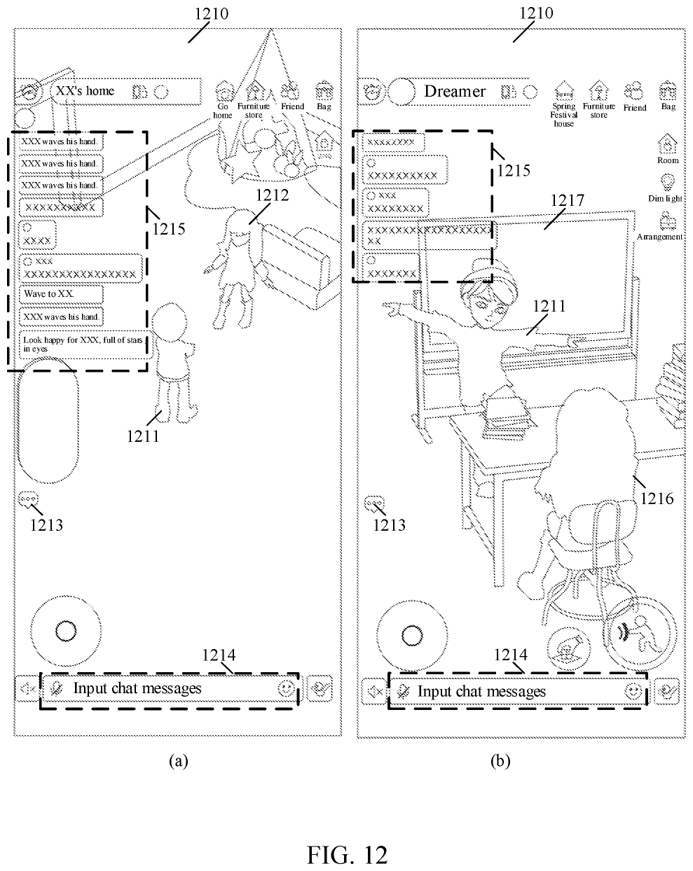

FIG. 12 shows a schematic diagram of an interface for a method for decorating a virtual room according to an embodiment of this application. FIG. 12(a) and (b) display two different second virtual rooms in a display interface 1210 separately, where a first virtual character 1211 and a second virtual character 1212 are displayed in the second virtual room.

For example, the display interface 1210 also displays a chat control 1213. The third control operation may be an operation of triggering the chat control 1213. An input control 1214 is displayed in response to the trigger operation on the chat control 1213, and the first account may input chat information in the input control 1214, where the chat information is sent for the second virtual character.

With reference to FIG. 12(a), the second virtual room is a virtual room owned by the second virtual character 1212. The display interface 1210 displays chat information of interaction between the first virtual character 1211 and the second virtual character 1212 for the target item. In some embodiments, the chat information may be displayed in an information display area 1215.

The chat information may be a comment string “The room is very nice” about the second virtual room or a comment string “The sofa looks very comfortable” about a virtual sofa in the second virtual room from the first virtual character 1211, or a reply string “I found this sofa at Xiao A's house” about the first virtual character 1211 from the second virtual character 1212, or special effect reminder information “The eyes of the first virtual character are full of stars” about the interaction between the first virtual character 1211 and the second virtual character 1212, or the like.

In some embodiments, the display interface 1210 displays a name string “XX's home” of the second virtual room.

Step 411: Display a third virtual character controlled by a fourth account in the second virtual room.

For example, the fourth account is a visitor account that enters the second virtual room.

The fourth account and the first account may have a friend relationship or not.

Step 412: Display chat information of interaction between the first virtual character and the third virtual character for the target item in the second virtual room in response to a fourth control operation on the first virtual character.

Similar to the third control operation, the fourth control operation refers to a control operation of the first virtual character about interaction for the fourth account, and includes but is not limited to triggering a chat control.

With reference to FIG. 12(b), the display interface 1210 also displays a third virtual character 1216 controlled by the fourth account, and the second virtual room is a virtual room owned by the third virtual character 1216 controlled by the fourth account. An input control 1214 is displayed in response to a trigger operation on the chat control 1213, and the first account may input chat information in the input control 1214, where the chat information is sent for the third virtual character.

Subsequently, the display interface 1210 displays chat information of interaction between the first virtual character 1211 and the third virtual character 1216 for a virtual blackboard 1217. In some embodiments, the chat information may be displayed in an information display area 1215.

The display content of the chat information may refer to the previous content and will not be repeated.

In some embodiments, according to the previous content, the placement location of the target item in the first virtual room may be a specified location or a default position. In some embodiments, step 406 may be implemented as follows:
controlling, in response to a placement operation on the target item, the first virtual character to place the target item in a specified location of the first virtual room or a default position, where the specified location is a position specified for placement in the first virtual room, and the default position is a placement location of the target item in the second virtual room.

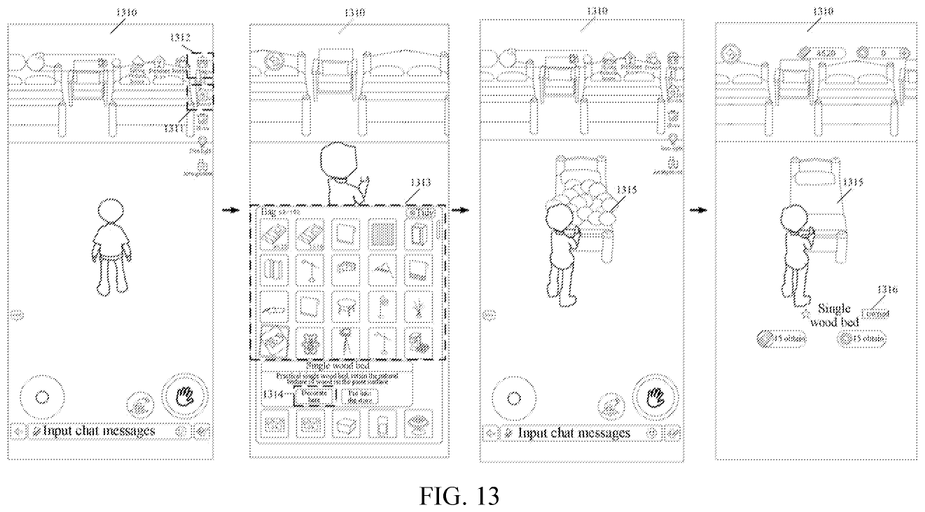

FIG. 13 shows a schematic diagram of an interface for a method for decorating a virtual room according to an embodiment of this application. A first virtual room is displayed in a display interface 1310, and a room switching control 1311 is displayed in the display interface 1310.

Subsequently, a first account triggers a backpack control 1312, a backpack display bar 1313 is displayed in the display interface 1310, and at least one virtual item owned by the first account is displayed in the backpack display bar 1313. After a virtual item to be arranged is determined, the first account performs a placement operation on a placement control 1314 to place the virtual item in a specified location or default position.

The placement operation may be a confirmation operation on the placement control 1314, or a drag operation for the virtual item. For example, the target item is a virtual single bed 1315. The virtual single bed 1315 is placed in the default position of the first virtual room in response to a click operation on the placement control 1314; or after selecting the virtual single bed 1315, the player drags the virtual single bed 1315 to the specified location, so as to place the virtual single bed 1315 in the specified location.

In some embodiments, ownership information 1316 corresponding to the virtual single bed 1315 is displayed in response to a selection operation on the virtual single bed 1315, to indicate the ownership of the virtual single bed 1315 by the first account. For example, a string “Already owned 1” is displayed on the periphery of the virtual single bed 1315, to indicate that the first account owns 1 virtual single bed 1315.

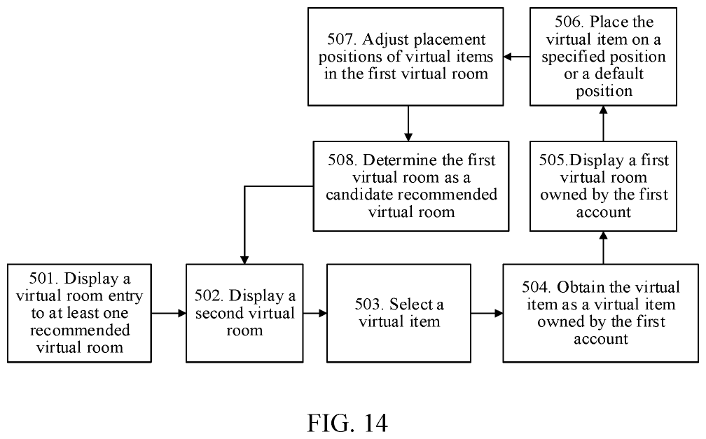

FIG. 14 shows a flowchart of a method for decorating a virtual room according to an embodiment of this application. This method is applied to a terminal that logs into a first account. This method includes the following steps:

Step 501: Display a virtual room entry to at least one recommended virtual room.

In some embodiments, the at least one recommended virtual room includes at least one of the following three types of virtual rooms: a sample virtual room provided by a back-end system or public account, where the public account provides information push services for at least one account; a virtual room customized by a second account, where the second account and the first account have a friend relationship in an instant messaging system or virtual world; and a virtual room customized by a third account, where the third account and the first account do not have a friend relationship in the instant messaging system or virtual world.

Step 502: Display a second virtual room in response to a confirmation operation on the virtual room entry to the second virtual room.

For example, the second virtual room is one of the at least one recommended virtual room.

Related description of the second virtual room may refer to the previous content and will not be repeated.

Step 503: Select a target item.

The first account may select the target item in the second virtual room according to its need. For example, if the player who logs into the first account desires to place a virtual carpet in his virtual room, the first account may select the virtual carpet in the second virtual room.

For example, a purchase interface for the target item is displayed in response to a selection operation on the target item.

In some embodiments, when the second virtual room is displayed, other accounts may also enter the second virtual room and select target items.

Step 504: Obtain the target item as a target item owned by the first account in response to a purchase operation on a purchase interface.

Related description of the purchase interface and the purchase operation may refer to the previous content and will not be repeated.

Step 505: Display the first virtual room owned by the first account in response to a switching operation.

Related description of the switching operation may refer to the previous content and will not be repeated.

Step 506: Control, in response to a placement operation on the target item, the first virtual character to place the target item in a specified location of the first virtual room or a default position.

For example, the specified location is a position specified for placement in the first virtual room, and the default position is a placement location of the target item in the second virtual room.

Related description of the placement operation may refer to the previous content and will not be repeated.

Step 507: Adjust placement locations of virtual items in the first virtual room.

After the first account controls the first virtual character to place the target item purchased from the second virtual room in the first virtual room, the first account may control the first virtual character to adjust the placement locations of all virtual items in the first virtual room.

For example, after the virtual carpet is placed in the specified location in the first virtual room, the first account may adjust the placement location of a virtual tea table in the first virtual room to achieve the goal of placing the virtual tea table on the virtual carpet.

Step 508: Determine the first virtual room as a candidate recommended virtual room.

After the arrangement of the first virtual room is completed, the first virtual room may be used as a candidate recommended virtual room. Subsequently, when another account needs to enter a virtual room, the first virtual room may be used as one of recommended virtual rooms while meeting the requirements of another account, and the virtual room entry to the first virtual room is displayed in the display interface of another account.

To sum up, in the method for decorating a virtual room according to this embodiment, the first virtual character is further displayed in the second virtual room to improve human-machine interaction efficiency.

In some embodiments, in the case that the first virtual character is displayed in the second virtual room, usage or experience of the target item by the first virtual character in the second virtual room may be displayed in response to a second control operation on the first virtual character, to simulate a real usage or experience scenario. A real purchase scenario may be simulated by displaying chat information of interaction between the first virtual character and the second virtual character or the third virtual character for the target item, or by displaying a virtual item bag.

In some embodiments, the first account may alternatively place the target item in the owned first virtual room, and the placement location may be selected by the first account independently or determined according to the position of the target item in the second virtual room.

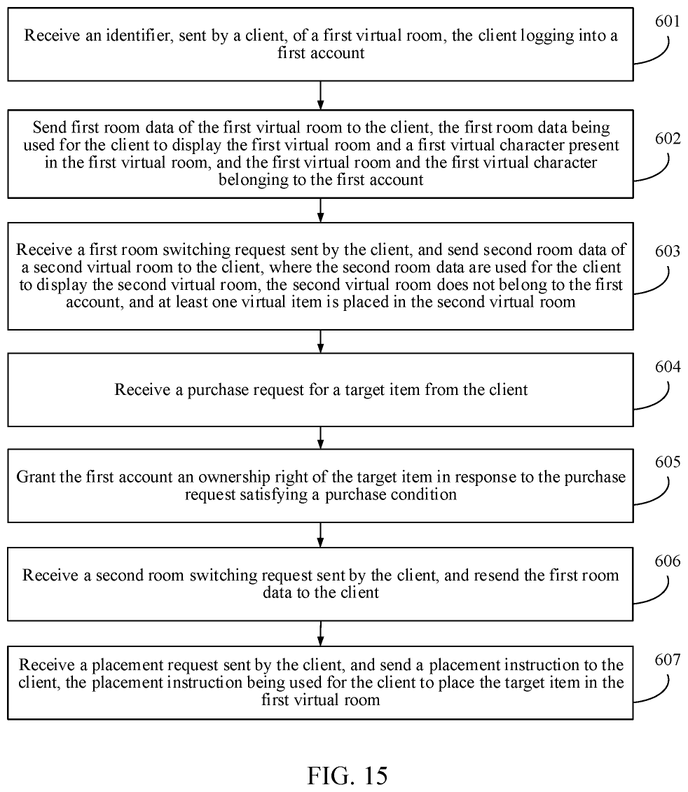

FIG. 15 shows a flowchart of a method for decorating a virtual room according to an embodiment of this application. This method is applied to a server. This method includes the following steps:

Step 601: Receive an identifier, sent by a client, of a second virtual room.

For example, the client logs into a first account.

Related description of the second virtual room may refer to the previous content and will not be repeated.

With reference to FIG. 4, in the interaction between the terminal and the server, step 602 is performed before step 402. For example, the identifier of the second virtual room is sent to the server by the client after receiving a confirmation operation on a virtual room entry to the second virtual room from the first account, and the server can determine a virtual room selected by the client according to the identifier of the second virtual room.

Step 602: Send the first room data of a first virtual room to the client.

For example, the first room data is used for the client to display the first virtual room and a first virtual character present in the first virtual room, and the first virtual room and the first virtual character belong to the first account.

In some embodiments, the first room data include, but are not limited to, at least one of the following data: area of the first virtual room, shape of the first virtual room, orientation of doors and windows in the first virtual room, quantity of virtual items in the first virtual room, types of virtual items in the first virtual room, and placement locations of the virtual items in the first virtual room.

With reference to FIG. 4, in the interaction between the terminal and the server, step 602 is also performed before step 401. For example, after receiving the first room data sent by the server, the client may display the first virtual room and a first virtual object according to the room data.

For example, the data included in the first room data are the following information: room area 45 square meters, 5 target items placed in the second virtual room, and placement locations of the 5 target items in the first virtual room. After receiving the first room data, the terminal controls a display interface to display the first virtual room with area of 45 square meters, and to display the 5 target items in the first virtual room according to their placement locations in the second virtual room.

Step 603: Receive a first room switching request sent by the client, and send second room data of the second virtual room to the client.

For example, the second room data is used for the client to display the second virtual room, the second virtual room does not belong to the first account, and at least one virtual item is placed in the second virtual room.

Related description of the virtual item may refer to the previous content and will not be repeated.

In some embodiments, the second room data include, but are not limited to, at least one type of the following data: area of the second virtual room, shape of the second virtual room, orientations of doors and windows in the second virtual room, quantity of virtual items in the second virtual room, types of virtual items in the second virtual room, and placement locations of the virtual items in the second virtual room.

With reference to FIG. 4, in the interaction between the terminal and the server, step 603 is performed after step 402. For example, after receiving the second room data of the second virtual room sent by the server, the client may display the second virtual room according to the second room data.

For example, the data included in the second room data are the following information: room area 45 square meters, 5 target items placed in the second virtual room, and placement locations of the 5 target items in the second virtual room. After receiving the foregoing room data, the terminal controls the display interface to display the second virtual room with area of 45 square meters, and to display the 5 target items in the second virtual room according to their placement locations in the second virtual room.

Step 604: Receive a purchase request for a target item from the client.

The purchase request is generated according to the purchase operation of the first account on a purchase interface. Related descriptions of the purchase interface and the purchase operation may refer to the previous content and will not be repeated.

In some embodiments, the purchase request includes, but is not limited to, at least one type of the following information: a name of the target item, item parameters of the target item, and a quantity of purchase resources for the target item.

With reference to FIG. 4, in the interaction between the terminal and the server, the purchase request is generated by the terminal after obtaining the purchase operation of the first account on the purchase interface. After receiving the purchase request, the server may confirm relevant information of the target item that the first account needs to purchase.

Step 605: Grant the first account an ownership right of the target item in response to the purchase request satisfying a purchase condition.

The purchase condition is determined according to the quantity of purchase resources for the target item and the quantity of purchase resources owned by the first account. In some embodiments, in a case that the quantity of purchase resources owned by the first account is not less than the quantity of purchase resources for the target item, it is determined that the purchase request satisfies the purchase condition.

In the case that the purchase request satisfies the purchase condition, the first account obtains the ownership right of the target item, and may determine the target item as a target item owned by the first account.

With reference to FIG. 4, in the interaction between the terminal and the server, steps 604, 605, and 404 are performed in the following sequence:

The client obtains a purchase operation of the first account on a purchase interface and generates the purchase request for a target item;
the client sends the purchase request for a target item to the server;
the server grants the first account the ownership right of the target item in response to the purchase request satisfying the purchase condition; and
the client obtains the target item as a target item owned by the first account according to the ownership right granted by the server.

Step 606: Receive a second room switching request sent by the client, and resend the first room data of the first virtual room to the client.

The second room switching request is similar to and may refer to the first room switching request and will not be repeated.

After receiving the first room data resent by the server, the client may redisplay the first virtual room.

Step 607: Receive a placement request sent by the client, and send a placement instruction to the client.

For example, the placement instruction is used for the client to place the target item in the first virtual room.

With reference to FIG. 4, in the interaction between the terminal and the server, the terminal generates the corresponding placement request after obtaining a placement operation of the first account on the target item; subsequently, the terminal sends the placement instruction to the client after receiving the placement request; and after receiving the placement instruction, the client places the target item in the first virtual room according to the instruction.

The placement location of the target item in the first virtual room is a specified location or default position, and the specific description may refer to the previous content and will not be repeated.

To sum up, in the method for decorating a virtual room according to this embodiment, the first account may be granted the ownership right of the target item in response to the purchase request sent by the client for the target item, so that the first account quickly obtains the required target item and human-machine interaction efficiency is improved.

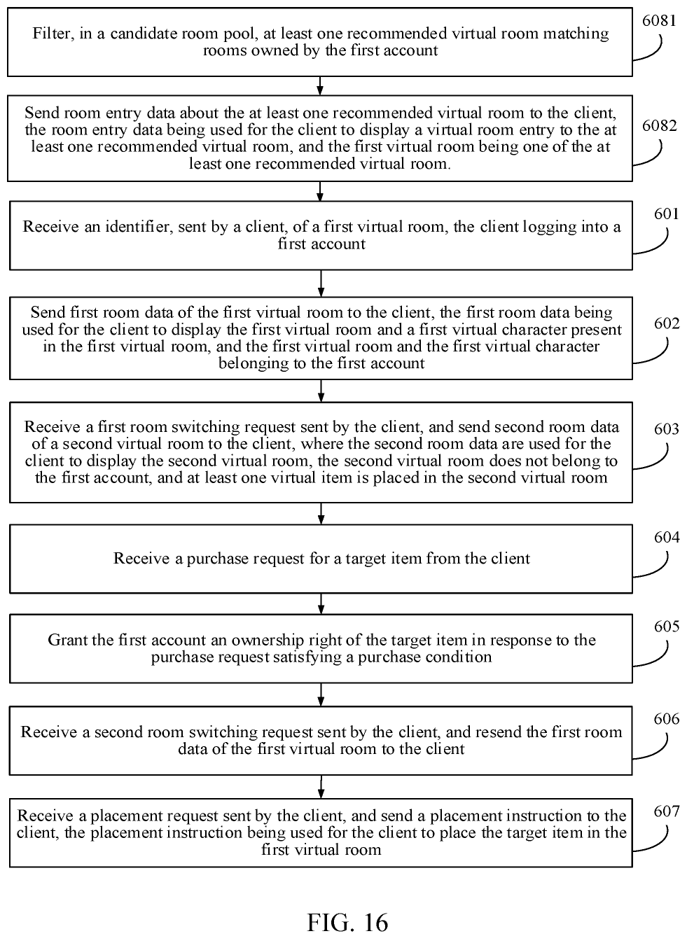

Based on FIG. 15, FIG. 16 shows a flowchart of a method for decorating a virtual room according to an embodiment of this application. This method is applied to a server. This method further includes the following steps:

Step 6081: Filter, in a candidate room pool, at least one recommended virtual room matching rooms owned by the first account.

In some embodiments, the candidate room pool includes at least one of the following three types of room pools:
an out-of-home room pool;
an at-home room pool; and
a random room pool.

The out-of-home room pool includes candidate virtual rooms where the homeowner account is off-line, the at-home room pool includes candidate virtual rooms where the homeowner account is on-line and is not in a recommended cooling-off period, and the random room pool includes candidate virtual rooms where the homeowner account is on-line and is in the recommended cooling-off period.

For example, the recommended cooling-off period refers to a time period during which virtual rooms satisfy a recommendation condition. The recommendation condition may be set according to specific requirements, for example, the recommendation condition is determined according to historical data or preference information of the first account.

For example, at a first time point, the homeowner account is on-line in a first room, and if the first room is not in the recommended cooling-off period, the first room is one in the at-home room pool; or if the first room is in the recommended cooling-off period, the first room is one in the random room pool. At a second time point, the homeowner account is off-line in a second room, the second room is one in the out-of-home room pool.

For example, the candidate virtual room included in the room pool may be an individual virtual room or a room combination of at least two virtual rooms. For example, the at-home room pool includes virtual rooms where the second account is on-line, and room combinations where the third account is on-line.

In some embodiments, random filtering algorithms corresponding to the three types of room pools have different random extraction probabilities.

The random extraction probabilities may be determined according to specific requirements. The random extraction probabilities are in ascending order as follows: the at-home room pool, the random room pool, and the out-of-home room pool. Alternatively, the random extraction probabilities are in ascending order as follows: the random room pool, the at-home room pool, and the out-of-home room pool.

In some embodiments, step 6081 may be implemented as follows:
determining a room area owned by the first account;
determining a reasonable quantity of items that matches the room area;
determining candidate virtual rooms corresponding to the reasonable quantity of items in the candidate room pool; and
randomly filtering out at least one recommended virtual room from the candidate virtual rooms.

The room area owned by the first account is used for indicating one of the following areas: a total area of all rooms owned by the first account, and an individual area of a virtual room where the first account is on-line.

For example, the first account has a room combination that includes 3 bedrooms and 1 living room, and the first account is on-line in the living room. The room area owned by the first account may be the total area of 3 bedrooms and 1 living room, or the individual area of the living room where the first account is currently present.

Step 6082: Send room entry data about at least one recommended virtual room to the client.

For example, the room entry data is used for the client to display a virtual room entry to the at least one recommended virtual room, and the second virtual room is one of the at least one recommended virtual room.

In some embodiments, the at least one recommended virtual room includes at least one of the following three types of virtual rooms: a sample virtual room provided by a back-end system or public account, where the public account provides information push services for at least one account; a virtual room customized by a second account, where the second account and the first account have a friend relationship in an instant messaging system or virtual world; and a virtual room customized by a third account, where the third account and the first account do not have a friend relationship in the instant messaging system or virtual world.

Related descriptions of the sample virtual room, the virtual room customized by the second account, and the virtual room customized by the third account may refer to the previous content and will not be repeated.

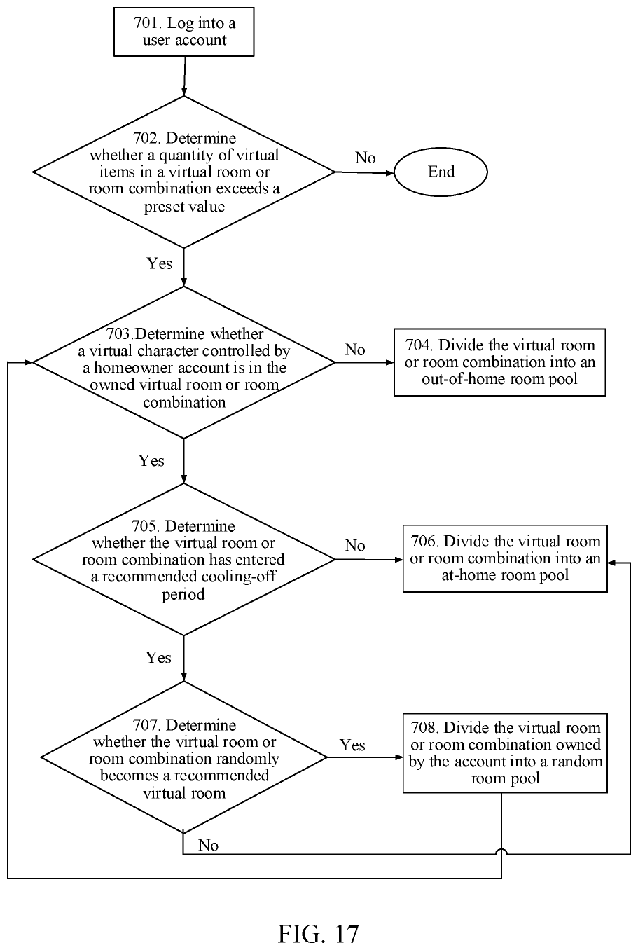

FIG. 17 shows a flowchart of dividing candidate room pools according to an embodiment of this application. The division of the candidate room pools includes the following steps:

Step 701: Log into a user account.

The user account refers to one or more of all accounts, including a first account.

After logging into at least one user account, type division of candidate room pools is performed on virtual rooms or room combinations owned by the user account. According to the previous content, the candidate room pools include three types: an out-of-home room pool, an at-home room pool, and a random room pool. Specific division steps are as follows.

Step 702: Determine whether a quantity of virtual items in a current virtual room or room combination exceeds a preset value.

Step 703 is performed in a case that the quantity of virtual items exceeds the preset value.

Step 703: Determine whether a virtual character controlled by a homeowner account is in the owned virtual room or room combination.

The virtual room or room combination owned by the homeowner account is the virtual room or room combination where the user account is currently present. For example, the user account is account 1, account 1 is in virtual room 1, and the homeowner account of the virtual room is account 2. Then, whether the virtual character controlled by the homeowner account in virtual room 1 is in virtual room 1 is determined.

Step 704 is performed when the virtual character controlled by the homeowner account is not in the owned virtual room or room combination, and step 705 is performed when the virtual character controlled by the homeowner account is in the owned virtual room or room combination.

Step 704: Divide the virtual room or room combination into an out-of-home room pool.

For example, when the virtual character controlled by the homeowner account is not in the owned virtual room or room combination, the user account logs in and enters the virtual room, and the virtual room or room combination where the user account is currently present (namely, the virtual room or room combination owned by the homeowner account) is divided into one in the out-of-home room pool.

Step 705: Determine whether the current virtual room or room combination has entered a recommended cooling-off period.

Step 706 is performed when the current virtual room or room combination has not entered the recommended cooling-off period, and step 707 is performed when the current virtual room or room combination has entered the recommended cooling-off period.

The description of the recommended cooling-off period may refer to the previous content and will not be repeated.

For example, when the virtual character controlled by the homeowner account is in the owned virtual room or room combination, the user account logs in and enters the virtual room. If the virtual room has not entered the recommended cooling-off period, the virtual room or room combination owned by the homeowner account (namely, the virtual room or room combination where the user account is currently present) is divided into one in the at-home room pool.

Step 706: Divide the virtual room or room combination owned by the user account into an at-home room pool.

In some embodiments, in a case that the virtual character controlled by the homeowner account leaves the virtual room or room combination, or in a case that the homeowner account is off-line, the virtual room or room combination owned by the homeowner account (namely, the virtual room or room combination where the user account is currently present) is removed from the at-home room pool and added to the out-of-home room pool.

Step 707: Determine whether the current virtual room or room combination immediately becomes a recommended virtual room.

Step 708 is performed when the current virtual room or room combination immediately becomes a recommended virtual room, and step 706 is performed when the current virtual room or room combination does not immediately become a recommended virtual room.

Step 708: Divide the virtual room or room combination into a random room pool.

In some embodiments, in a case that the random room pool is full, if a new virtual room or room combination is randomly selected as a recommended virtual room, the user account is forced to exit from the current virtual room or room combination and reenters a new virtual room or room combination, and step 703 is performed back to re-determine whether the virtual character controlled by the homeowner account is in the owned virtual room or room combination.

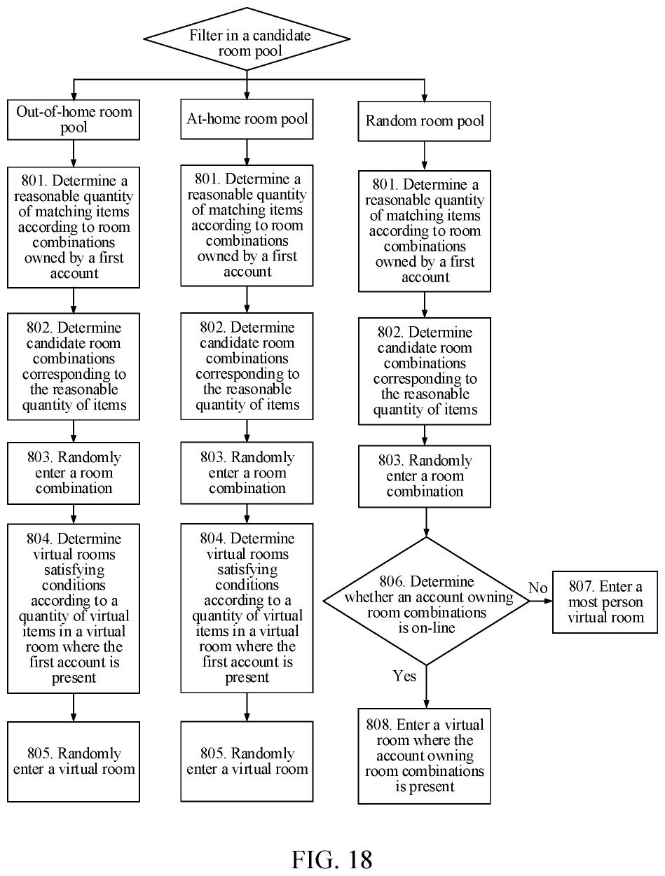

The division of candidate room pools based on room combinations is used as an example. FIG. 18 shows a flowchart of entering a virtual room according to an embodiment of this application.

During filtering in the three types of candidate room pools, the following steps are included:

Step 801: Determine a reasonable quantity of matching items according to room combinations owned by a first account;

Step 802: Determine candidate room combinations corresponding to the reasonable quantity of items;

Step 803: Randomly enter a room combination.

The reasonable quantity of matching items can be determined according to the total area of all virtual rooms owned by the first account, and the quantity is a sum of individual reasonable quantities of items in all virtual rooms. Subsequently, determine the corresponding candidate room combinations according to the reasonable quantity of items, and randomly enter a room combination.

For room combinations in an out-of-home room pool and an at-home room pool, the following steps are further included:

Step 804: Determine virtual rooms satisfying conditions according to a quantity of virtual items in a virtual room where the first account is present;

Step 805: Randomly enter a virtual room.

After a first quantity of virtual items in the virtual room where the first account is present and a second quantity of virtual items in each virtual room in a room combination are obtained, the second quantity is determined to determine the virtual rooms satisfying conditions. For example, in a case that the second quantity is not less than the first quantity, the virtual rooms corresponding to the second quantity are determined as the virtual rooms satisfying conditions. Subsequently, randomly enter a virtual room.

For room combinations in a non-random room pool, the following steps are further included:

Step 806: Determine whether an account owning room combinations is on-line.

Step 807 is performed in a case that the account owning room combinations is off-line; or step 808 is performed in a case that the account owning room combinations is on-line.

Step 807: Enter a most person virtual room.

The most person virtual room refers to one type of the following virtual rooms: a room with the largest number of historical visitors; and a room with the largest number of real-time historical visitors.

Step 808: Enter a virtual room where the account owning room combinations is present.

After randomly entering a room combination, the on-line status of the account owning room combinations is determined: and when the account is on-line, the virtual room where the account is present is preferred to enter; or when the account is off-line, the most person virtual room is selected to enter.

To sum up, in the method for decorating a virtual room according to an embodiment of this application, at least one recommended virtual room matching the rooms owned by the first account is filtered in the candidate room pool, so that the first account can quickly enter the corresponding virtual room.

The following describes apparatus embodiments of this application. For details that are not elaborated in the apparatus embodiments, reference may be made to the corresponding descriptions in the foregoing method embodiments, and details are not described herein again.

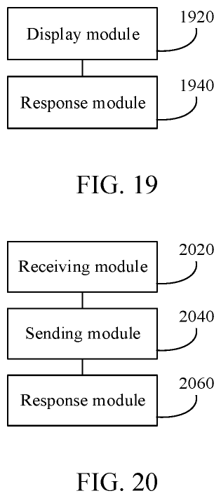

FIG. 19 shows a schematic diagram of an apparatus for decorating a virtual room according to an embodiment of this application. The apparatus includes:
a display module 1920, configured to display a first virtual room and a first virtual character, the first virtual room and the first virtual character belonging to a first account;
a response module 1940, configured to display a second virtual room in response to a first switching operation of entering the second virtual room, and control the first virtual character to enter the second virtual room, where the second virtual room does not belong to the first account, and at least one virtual item is placed in the second virtual room;
the response module 1940, further configured to display a purchase interface for a target item in response to a selection operation on the target item among the at least one virtual item;
the response module 1940, further configured to obtain the target item as a virtual item owned by the first account in response to a purchase operation on the purchase interface;
the response module, further configured to control the first virtual character to return to the first virtual room in response to a second switching operation of returning to the first virtual room; and
the response module, further configured to place the target item in the first virtual room in response to a placement operation on the target item.

In some embodiments, the display module 1920 is configured to display a virtual room entry to at least one recommended virtual room, the second virtual room being one of the at least one recommended virtual room; and determine to obtain the first switching operation in response to a virtual room entry to the first virtual room being selected.

In some embodiments, the at least one recommended virtual room includes at least one of the following three types of virtual rooms: a sample virtual room provided by a back-end system or public account, where the public account provides information push services for at least one account; a virtual room customized by a second account, where the second account and the first account have a friend relationship in an instant messaging system or virtual world; and a virtual room customized by a third account, where the third account and the first account do not have a friend relationship in the instant messaging system or virtual world.

In some embodiments, the first virtual room belongs to a target room combination, and the target room combination includes at least two virtual rooms; and the first virtual room is a virtual room where a second virtual character controlled by a homeowner account is present in the target room combination, or the first virtual room is a virtual room with most third virtual characters controlled by a visitor account in the target room combination.

In some embodiments, the display module 1920 is configured to display, when one target item is selected, item description of the target item and a first purchase interface; or display, when the selected target item is an item combination of at least two matching target items, item description of the item combination and a second purchase interface; where the item description includes: at least one of an item name, a quantity of purchase resources, and an ownership of the target item by the first account.

In some embodiments, the display module 1920 is further configured to display an optional item configuration for the target item; and the response module 1940 is further configured to change item parameters of the target item in response to a selection operation on the optional item configuration, the item parameters including at least one of color, style, model, size, and material.

In some embodiments, the response module 1940 is further configured to display movement of the first virtual character in the first virtual room in response to a first movement control operation on the first virtual character; or display movement of the first virtual character in the second virtual room in response to a second movement control operation on the first virtual character.

In some embodiments, the response module 1940 is configured to display the purchase interface for the target item in response to a click operation on the target item; or display the purchase interface for the target item in response to the distance between the first virtual character and the target item being less than a threshold.

In some embodiments, the response module 1940 is further configured to display usage or experience of the target item by the first virtual character in the second virtual room in response to a second control operation on the first virtual character.

In some embodiments, the display module 1920 is further configured to display the second virtual character controlled by the homeowner account in the second virtual room, the homeowner account being an owner account of the second virtual room; and the response module 1940 is further configured to display chat information of interaction between the first virtual character and the second virtual character for the target item in the second virtual room in response to a third control operation on the first virtual character.

In some embodiments, the display module 1920 is further configured to display a third virtual character controlled by a fourth account in the second virtual room, the fourth account being a visitor account that enters the second virtual room; and the response module 1940 is further configured to display chat information of interaction between the first virtual character and the third virtual character for the target item in the second virtual room in response to a fourth control operation on the first virtual character.

In some embodiments, the display module 1920 is further configured to display a virtual item bag held by the first virtual character in a case that the target item is successfully obtained as the virtual item owned by the first account, the virtual item bag being used for indicating packaging of the target item.

In some embodiments, the response module 1940 is further configured to control, in response to a placement operation on the target item, the first virtual character to place the target item in a specified location of the first virtual room or a default position, the specified location being a position specified for placement in the first virtual room, and the default position being a placement location of the target item in the second virtual room.

FIG. 20 shows a schematic diagram of an apparatus for decorating a virtual room according to an embodiment of this application. The apparatus includes:
a receiving module 2020, configured to receive an identifier, sent by a client, of a first virtual room, the client logging into a first account;
a sending module 2040, configured to send first room data of the first virtual room to the client, the first room data being used for the client to display the first virtual room and a first virtual character present in the first virtual room, and the first virtual room and the first virtual character belonging to the first account;
the receiving module 2020, further configured to receive a first room switching request sent by the client, and send second room data of a second virtual room to the client, where the second room data are used for the client to display the second virtual room, the second virtual room does not belong to the first account, and at least one virtual item is placed in the second virtual room;
the receiving module 2020, further configured to receive a purchase request for a target item from the client; and
a response module 2060, configured to grant the first account an ownership right of the target item in response to the purchase request satisfying a purchase condition.

The receiving module 2020 is further configured to receive a second room switching request sent by the client, and resend the first room data to the client; and
the receiving module 2020 is further configured to receive a placement request sent by the client, and send a placement instruction to the client, the placement instruction being used for the client to place the target item in the first virtual room.

In some embodiments, the sending module 2040 is further configured to filter, in a candidate room pool, at least one recommended virtual room matching rooms owned by the first account; and send room entry data about the at least one recommended virtual room to the client, the room entry data being used for the client to display a virtual room entry to the at least one recommended virtual room, and the second virtual room being one of the at least one recommended virtual room.

In some embodiments, the at least one recommended virtual room includes at least one of the following three types of virtual rooms: a sample virtual room provided by a back-end system or public account, where the public account provides information push services for at least one account; a virtual room customized by a second account, where the second account and the first account have a friend relationship in an instant messaging system or virtual world; and a virtual room customized by a third account, where the third account and the first account do not have a friend relationship in the instant messaging system or virtual world.

In some embodiments, the sending module 2040 is configured to determine a room area owned by the first account; determining a reasonable quantity of items that matches the room area; determining candidate virtual rooms corresponding to the reasonable quantity of items in the candidate room pool; and randomly filter out the at least one recommended virtual room from the candidate virtual rooms.

In some embodiments, the candidate room pool includes at least one of the following three types of room pools: an out-of-home room pool; an at-home room pool; and a random room pool. The out-of-home room pool includes candidate virtual rooms where the homeowner account is off-line, the at-home room pool includes candidate virtual rooms where the homeowner account is on-line and is not in a recommended cooling-off period, and the random room pool includes candidate virtual rooms where the homeowner account is on-line and is in the recommended cooling-off period.

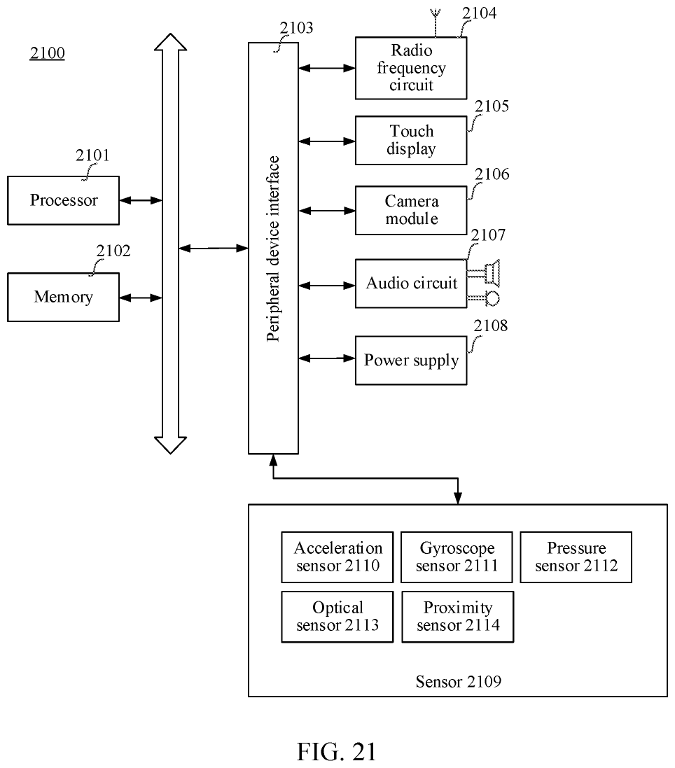

FIG. 21 shows a structural block diagram of a terminal 2100 according to an embodiment of this application. The terminal 2100 may be: a smart phone, a tablet computer, a moving picture experts group audio layer III (MP3) player, a moving picture experts group audio layer IV (MP4) player, a notebook computer, or a desktop computer. The terminal 2100 may also be referred to as another name such as user equipment, a portable terminal, a laptop terminal, or a desktop terminal.

Generally, terminal 2100 includes: a processor 2101 and a memory 2102.

The processor 2101 may include one or more processing cores, for example, a 4-core processor or an 8-core processor. In some embodiments, processor 2101 may further include an artificial intelligence (AI) processor. The AI processor is configured to process computing operations related to machine learning.

Memory 2102 may include one or more computer-readable storage media. The computer-readable storage medium may be non-transient. In some embodiments, the non-transient computer-readable storage medium in the memory 2102 is used for storing at least one instruction, and the at least one instruction is executed by the processor 2101 to implement the method for decorating a virtual room according to the method embodiments of this application.

In some embodiments, the terminal 2100 further in some embodiments includes: a peripheral device interface 2103 and at least one peripheral device.

The peripheral device interface 2103 may be configured to connect at least one peripheral device related to input/output (I/O) to the processor 2101 and the memory 2102.

A radio frequency circuit 2104 is configured to receive and transmit radio frequency (RF) signals, also referred to as electromagnetic signals. The radio frequency circuit 2104 communicates with a communication network and other communication devices through electromagnetic signals.

Touch display 2105 is configured to display a user interface (UI).

Camera component 2106 is configured to capture images or videos.

Audio circuit 2107 may include a microphone and a speaker.

Power supply 2108 is configured to supply power to components in terminal 2100.

In some embodiments, terminal 2100 further includes one or more sensors 2109. The one or more sensors 2109 include but are not limited to: an acceleration sensor 2110, a gyroscope sensor 2111, a pressure sensor 2112, an optical sensor 2113, and a proximity sensor 2114.

A person skilled in the art may understand that the structure shown in FIG. 21 constitutes no limitation on the terminal device 2100, and the terminal device may include more or fewer components than those shown in the figure, or some components may be combined, or a different component deployment may be used.

An embodiment of this application further provides a computer device. The computer device includes: a processor and a memory, the memory storing at least one computer program, and the at least one computer program being loaded and executed by the processor to implement the method for decorating a virtual room according to the foregoing embodiments.

An embodiment of this application further provides a computer-readable storage medium, the storage medium storing a computer program, and the computer program being executed by a processor to implement the method for decorating a virtual room according to the foregoing embodiments.

An embodiment of this application further provides a chip, the chip including programmable logic circuits and/or program instructions, and the chip being run to implement the method for decorating a virtual room according to the foregoing embodiments.

An embodiment of this application further provides a computer program product, computer instructions being stored in a computer-readable storage medium, and a processor reading and executing the computer instructions from the computer-readable storage medium to implement the method for decorating a virtual room according to the foregoing embodiments.

It is to be understood that the term “plurality” mentioned in the specification means two or more. The term “and/or” describes an association relationship between associated objects and represents three relationships. For example, A and/or B may represent only A exists, both A and B exist, and only B exists. The character “/” generally indicates an “or” relationship between successive associated objects.

A person of ordinary skill in the art may understand that all or some of the steps of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

The foregoing descriptions are merely optional embodiments of this application, but are not intended to limit this application. Any modification, equivalent replacement, or improvement made within the spirit and principle of this application shall fall within the protection scope of this application.

What is claimed is:

1. A method for decorating a virtual room, performed by a terminal that logs into a first account, and the method comprising:
displaying a first virtual room and a first virtual character in the first virtual room, the first virtual room and the first virtual character being associated with a first account;
displaying a second virtual room, and controlling the first virtual character to enter the second virtual room, at least one virtual item being placed in the second virtual room;
displaying a purchase interface for a target item in the second virtual room in response to a selection operation on the target item;
purchasing the target item by the first account in response to a purchase operation on the purchase interface;
controlling the first virtual character to return to the first virtual room; and
placing the target item in the first virtual room in response to a placement operation.

2. The method according to claim 1, wherein displaying a second virtual room comprises:
displaying a virtual room entry to at least one recommended virtual room, the second virtual room being one of the at least one recommended virtual room; and
determining to obtain a first switching operation in response to a virtual room entry to the second virtual room being selected.

3. The method according to claim 2, wherein the at least one recommended virtual room comprises at least one of the following types of virtual rooms:
a sample virtual room provided by public account, the public account providing information push services;
a virtual room customized by a second account, the second account and the first account having a friend relationship; and
a virtual room customized by a third account, the third account and the first account having no friend relationship.

4. The method according to claim 1, wherein the first virtual room belongs to a target room combination, and the target room combination comprises at least two virtual rooms; and
the first virtual room is a virtual room where a second virtual character controlled by a homeowner account is in the target room combination, or the first virtual room is a virtual room with most third virtual characters controlled by a visitor account in the target room combination.

5. The method according to claim 1, wherein the displaying a purchase interface for a target item comprises:
displaying, in a case that one target item is selected, item description of the target item and a first purchase interface;
or
displaying, in a case that the selected target item is an item combination of at least two matching virtual items, item description of the item combination and a second purchase interface;
the item description comprising at least one of an item name, a quantity of purchase resources, and an ownership of the target item by the first account.

6. The method according to claim 5, the method further comprising:
displaying an item configuration for the target item; and
changing item parameters of the target item in response to a selection operation on the item configuration, the item parameters comprising at least one of color, style, model, size, and material.

7. The method according to claim 1, the method further comprising:
displaying movement of the first virtual character in the first virtual room in response to a first movement control operation on the first virtual character;
or
displaying movement of the first virtual character in the second virtual room in response to a second movement control operation on the first virtual character.

8. The method according to claim 7, wherein the displaying a purchase interface for a target item in response to a selection operation on the target item among the at least one virtual item comprises:
displaying the purchase interface for the target item in response to a click operation on the target item;
or
displaying the purchase interface for the target item in response to the distance between the first virtual character and the target item being less than a threshold.

9. The method according to claim 7, the method further comprising:
displaying user experience of the target item by the first virtual character in the second virtual room in response to a second control operation on the first virtual character.

10. The method according to claim 7, the method further comprising:
displaying the second virtual character controlled by the homeowner account in the second virtual room, the homeowner account being an owner account of the second virtual room; and
displaying chat information of interaction between the first virtual character and the second virtual character for the virtual item in the second virtual room in response to a third control operation on the first virtual character.

11. The method according to claim 7, the method further comprising:
displaying a third virtual character controlled by a fourth account in the second virtual room, the fourth account being a visitor account that enters the second virtual room; and
displaying chat information of interaction between the first virtual character and the third virtual character for the virtual item in the second virtual room in response to a fourth control operation on the first virtual character.

12. The method according to claim 7, the method further comprising:
displaying a virtual item bag held by the first virtual character in a case that the target item is successfully purchased by the first account, the virtual item bag being used for indicating packaging of the target item.

13. The method according to claim 1, wherein the placing the target item in the first virtual room in response to a placement operation on the target item comprises:
controlling, in response to a placement operation on the target item, the first virtual character to place the target item in a specified location of the first virtual room or a default position, the specified location being a location specified for placement in the first virtual room, and the default position being a placement location of the target item in the second virtual room.

14. A method for decorating a virtual room, the method being performed by a server, and the method comprising:
receiving an identifier, transmitted by a client, of a first virtual room, the client being logged into a first account;
transmitting first room data of the first virtual room to the client, the first room data being used for the client to display the first virtual room and a first virtual character in the first virtual room, and the first virtual room and the first virtual character being associated with the first account;
receiving a first room switching request transmitted by the client, and transmitting second room data of a second virtual room to the client, the second room data being used for the client to display the second virtual room, at least one virtual item being placed in the second virtual room;
receiving a purchase request for a target item from the client;
granting the first account an ownership right of the target item in response to the purchase request satisfying a purchase condition.
receiving a second room switching request transmitted by the client, and transmitting the first room data to the client; and
receiving a placement request transmitted by the client, and transmitting a placement instruction to the client, the placement instruction instructing the client to place the target item in the first virtual room.

15. The method according to claim 14, the method further comprising:
filtering, in a candidate room pool, at least one recommended virtual room matching rooms owned by the first account; and
transmitting room entry data about the at least one recommended virtual room to the client, the room entry data being used for the client to display a virtual room entry to the at least one recommended virtual room, and the second virtual room being one of the at least one recommended virtual room.

16. The method according to claim 15, wherein the at least one recommended virtual room comprises at least one of the following types of virtual rooms:
a sample virtual room provided by a public account, the public account providing information push services for at least one account;
a virtual room customized by a second account, the second account and the first account having a friend relationship; and
a virtual room customized by a third account, the third account and the first account having no friend relationship.

17. The method according to claim 15, wherein the filtering, in a candidate room pool, at least one recommended virtual room matching rooms owned by the first account comprises:
determining a room area owned by the first account;
determining a reasonable quantity of items that matches the room area;
determining candidate virtual rooms corresponding to the reasonable quantity of items in the candidate room pool; and
filtering out the at least one recommended virtual room from the candidate virtual rooms.

18. The method according to claim 17, wherein filtering algorithms corresponding to the three types of room pools have different random extraction probabilities.

19. A non-transitory computer-readable storage medium, the storage medium storing a computer program, and the computer program being executed by one or more processors to implement a method for decorating a virtual room, performed by a terminal that logs into a first account, and the method comprising:
displaying a first virtual room and a first virtual character in the first virtual room, the first virtual room and the first virtual character being associated with a first account;
displaying a second virtual room, and controlling the first virtual character to enter the second virtual room, at least one virtual item being placed in the second virtual room;
displaying a purchase interface for a target item in the second virtual room in response to a selection operation on the target item;
purchasing the target item by the first account in response to a purchase operation on the purchase interface;
controlling the first virtual character to return to the first virtual room; and
placing the target item in the first virtual room in response to a placement.

20. The computer-readable storage medium according to claim 19, wherein displaying a second virtual room comprises:
displaying a virtual room entry to at least one recommended virtual room, the second virtual room being one of the at least one recommended virtual room; and
determining to obtain a first switching operation in response to a virtual room entry to the second virtual room being selected.
